(19) United States
(12) Patent Application Publication
(10) Pub. No.: US 2008/0060710 A1
(43) Pub. Date: Mar. 13, 2008

(54) CONTROLLABLE MAGNETORHEOLOGICAL FLUID VALVE, DEVICES, AND METHODS

(76) Inventors: J. David Carlson, Cary, NC (US); Fernando Goncalves, Raleigh, NC (US); David M. Catanzarite, Edinboro, PA (US); David R. Dobbs, Norwalk, CT (US)

Correspondence Address: LORD CORPORATION;PATENT & LEGAL SERVICES, 111 LORD DRIVE, CARY, NC, 27512, US

(21) Appl. No.: 11/844,548

(22) Filed: Aug. 24, 2007

Related U.S. Application Data
(60) Provisional application No. 60/823,398, filed on Aug. 24, 2006.

(51) Int. Cl. F16K 31/06

(52) U.S. Cl. 137/807

(57) ABSTRACT

A controllable magnetorheological fluid valve for controlling magnetorheological fluid. The controllable fluid valve includes a magnetorheological fluid conduit with a magnetorheological fluid path. The controllable fluid valve includes a north magnetic pole and a south magnetic pole, with the south magnetic pole proximate the north magnetic pole with a magnetic discontinuity spacer between the south magnetic pole and the north magnetic pole wherein the spacer forces nontraversing magnetic flux lines from said north pole out into the magnetorheological fluid path and then back into the south pole.

This claims priority to U.S. Provisional Patent Application 60/823,398 filed Aug. 24, 2006, which is hereby incorporated by reference.

### FIELD OF THE INVENTION

The invention relates to the field of controllable magnetorheological fluid valves. The invention relates to the field of controllable magnetorheological fluid devices. The invention relates to methods of controlling magnetorheological fluids. More particularly the invention relates to the field of controlling magnetorheological fluid valves, magnetorheological fluid devices, and magnetorheological fluids with magnetic fields.

### BACKGROUND OF THE INVENTION

There is a need for controllable magnetorheological fluid valves. There is a need for controllable magnetorheological fluid devices. There is a need for methods of controlling magnetorheological fluids.

### SUMMARY OF THE INVENTION

In an embodiment the invention includes a controllable fluid valve for controlling a magnetorheological fluid. The controllable fluid valve preferably includes a magnetorheological fluid flow conduit with a magnetorheological fluid flow path, a north magnetic pole and a south magnetic pole, with the south magnetic pole proximate the north magnetic pole with a gradient producing spacer between the south magnetic pole and the north magnetic pole wherein the south magnetic pole and the north magnetic pole generate a plurality of nontraversing magnetic field flux lines that extend into the magnetorheological fluid flow path.

In an embodiment the invention includes a controllable fluid valve for controlling a magnetorheological fluid. The controllable fluid valve preferably includes a magnetorheological fluid conduit with a magnetorheological fluid path. The controllable fluid valve preferably includes a north magnetic pole and a south magnetic pole, the south magnetic pole proximate the north magnetic pole with a gradient producing spacer between the south magnetic pole and the north magnetic pole wherein the spacer forces a plurality of magnetic flux lines from the north pole out into the magnetorheological fluid path and then back into the south pole.

In an embodiment the invention includes a controllable fluid valve for controlling a magnetorheological fluid. The controllable fluid valve preferably includes a magnetorheological fluid conduit with a magnetorheological fluid path, a north magnetic pole and a south magnetic pole, with the south magnetic pole proximate the north magnetic pole with a nonmagnetic spacer between the south magnetic pole and the north magnetic pole wherein the nonmagnetic spacer forces a plurality of magnetic flux lines from the north pole out into the magnetorheological fluid path and then back into the south pole.

In an embodiment the invention includes a method of controlling magnetorheological fluid flow. The method preferably includes providing a magnetorheological fluid flow conduit with a magnetorheological fluid flow path, the fluid flow path having a fluid flow axis. The method preferably includes providing a north magnetic pole and a south magnetic pole disposed radially from the fluid flow axis along a radially extending line r, with the north magnetic pole spaced from the south magnetic pole along the fluid flow path by a gradient producing spacer. The method preferably includes producing a magnetic field H with the north magnetic pole and the south magnetic pole, the magnetic field H having a magnetic field radial component Hᵣ, wherein the change in the magnetic field radial component relative to the change in radial distance is nonzero.

In an embodiment the invention includes a method of controlling magnetorheological fluid flow. The method preferably includes providing a magnetorheological fluid flow conduit with a magnetorheological fluid flow path. The method preferably includes providing a north magnetic pole and a south magnetic pole, and producing a magnetic field with the north magnetic pole and the south magnetic pole, with the magnetic field extending into the magnetorheological fluid flow path while inhibiting the magnetic field from traversing the magnetorheological fluid flow path.

In an embodiment the invention includes a method of making a magnetorheological fluid flow control valve. The method preferably includes providing a magnetorheological fluid flow conduit with a magnetorheological fluid flow path. The method preferably includes providing a north magnetic pole and a south magnetic pole, and disposing the south magnetic pole proximate the north magnetic pole with a spacer between the south magnetic pole and the north magnetic pole wherein the south magnetic pole and the north magnetic pole generate a nontraversing magnetic field that extends into the magnetorheological fluid flow path.

In an embodiment the invention includes a motion control device. The motion control device preferably includes a magnetorheological fluid path containing a magnetorheological fluid. The motion control device preferably includes a north magnetic pole and a south magnetic pole, the south magnetic pole proximate the north magnetic pole with a spacer between the south magnetic pole and the north magnetic pole wherein the south magnetic pole and the north magnetic pole generate a nontraversing magnetic field that extends into the magnetorheological fluid path.

In an embodiment the invention includes a motion control device. The motion control device preferably includes a magnetorheological fluid path containing a magnetorheological fluid with a device wall. The device preferably includes a north magnetic pole and a south magnetic pole proximate the device wall. Preferably the south magnetic pole is proximate the north magnetic pole with a flux line gradient producer between the south magnetic pole and the north magnetic pole wherein the south magnetic pole and the north magnetic pole generate a plurality of magnetic field flux lines that extends out from the device wall and into the magnetorheological fluid path and provide an area of high field gradient proximate the device wall.

In an embodiment the invention includes a method of controlling magnetorheological fluid flow. The method preferably includes providing an electromagnet. The method preferably includes providing a magnetorheological fluid. The method preferably includes providing a magnetorheological fluid flow conduit with a conduit wall for containing the magnetorheological fluid. Preferably the magnetorheological fluid flow conduit has a magnetorheological fluid flow path along the conduit wall. The method preferably includes producing a magnetic gradient in the magnetorheological fluid proximate the conduit wall with the electromagnet.

In an embodiment the invention includes a controllable fluid valve for controlling a magnetorheological fluid. The controllable fluid valve preferably includes a magnetorheological fluid conduit with a magnetorheological fluid path and a magnetic field flux line generator. The magnetic field flux line generator preferably includes a magnetic field generator with a north magnetic pole and a south magnetic pole, with the south magnetic pole proximate the north magnetic pole with a gradient producing spacer between the south magnetic pole and the north magnetic pole wherein the south magnetic pole and the north magnetic pole generate a plurality of magnetic field flux lines that extend into the magnetorheological fluid path.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1A shows a controllable fluid valve.

FIG. 1B shows the controllable fluid valve of FIG. 1A with magnetorheological fluid magnetic particles forming a blockage jam.

FIG. 2A shows a controllable fluid valve cross section with magnetic flux path lines shown as dashed lines.

FIG. 2B shows a finite element model of a gradient field embodiment of a controllable fluid valve.

FIG. 3A shows a controllable fluid valve cross section.

FIG. 3B shows a plot for Pressure vs. Flow Rate for four current levels supplied to the controllable fluid valve magnetic field generator EM coil.

FIG. 4A shows a controllable fluid valve cross section with a blockage jam.

FIG. 4B shows a plot for Peak Jamming Pressure vs Current.

FIG. 5A shows a controllable fluid valve cross section.

FIG. 5B shows a controllable fluid valve cross section.

FIG. 5C shows a controllable fluid valve cross section.

FIG. 5D shows a controllable fluid valve cross section.

FIG. 5E shows a controllable fluid valve cross section.

FIG. 5F shows a controllable fluid valve cross section.

FIG. 5G shows a controllable fluid valve cross section.

FIGS. 6A-D show views of a controllable fluid valve.

FIG. 7A shows flux paths a controllable fluid valve cross section.

FIG. 7B shows a finite element model flux paths of a controllable fluid valve cross section.

FIG. 8A shows flux paths with a controllable fluid valve cross section.

FIG. 8B shows a finite element model flux paths of a controllable fluid valve cross section.

FIG. 9 shows flux paths with a motion control device cross section.

FIG. 10A shows a motion control device controllable fluid piston cross section.

FIG. 10B shows a motion control device controllable fluid piston perspective cross section.

FIG. 11A shows a motion control device controllable fluid piston cross section.

FIG. 11B shows a motion control device controllable fluid piston perspective cross section.

FIG. 11C shows a motion control device controllable fluid piston perspective view.

FIG. 11D shows a motion control device controllable fluid piston top view.

FIG. 11E shows a motion control device controllable fluid piston perspective cross section.

FIGS. 11F-N show motion control device controllable fluid piston top views as the larger diameter conduits are progressively jammed with magnetic particle blockage jams.

FIGS. 12A-E illustrate a motion control device with cross-section views.

FIG. 13A shows a side view of a motion control device.

FIG. 13B illustrates a motion control device installed on a steering column.

FIG. 14A illustrates motion control damper devices mounted in parallel around a steering column.

FIG. 14B illustrates motion control damper devices mounted in parallel around a steering column.

FIG. 15A shows a motion control device cross-section view of a rotary coupler for a roll bar application.

FIG. 15B shows a motion control device cross-section view of a rotary coupler for a roll bar application.

FIG. 15C shows a perspective side view of a roller ramp detail for use in the FIG. 15A-B device.

FIG. 16 shows a motion control device cross-section view of a rotary coupler FIG. 17A shows a fluid flow conduit with magnetic flux lines.

FIG. 17B shows a controllable fluid valve cross section with magnetic flux lines.

FIG. 17C shows a controllable fluid valve cross section with magnetic flux lines.

FIG. 17D shows a controllable fluid valve cross section with two fluid conduits and magnetic flux lines.

FIG. 18A shows a motion control device controllable fluid piston damper side view.

FIG. 18B shows a motion control device controllable fluid piston damper cross section view.

FIG. 18C shows an enlargement of the fluid piston damper cross section view from FIG. 18B.

FIG. 19 shows a method/system for controlling a motion control device controllable fluid piston damper.

FIG. 20 shows a method/system for controlling a motion control device controllable fluid piston damper.

FIG. 21 shows a method/system for controlling a controllable fluid valve.

FIG. 22 shows a plot of current vs. time for controlling a controllable fluid valve.

FIG. 23 illustrates a method of controlling a controllable fluid valve.

FIG. 24A illustrates a motion control device controllable fluid piston damper with a pressure relief valve with a pressure relief blockage jam of magnetic particles.

FIG. 24B illustrates how a high critical force velocity of the motion control device controllable fluid piston damper removes the pressure relief blockage jam of magnetic particles and relieves the critical high force velocity pressure.

FIG. 25A is a cross section view of a motion control device with a piston damper with a pressure relief valve with a pressure relief blockage jam of magnetic particles.

FIG. 25B is a cross section view of a motion control device with a piston damper with a pressure relief valve with a pressure relief blockage jam of magnetic particles.

FIG. 25C is a cross section view of a motion control device with a piston damper with two pressure relief valves with pressure relief blockage jams of magnetic particles.

FIG. 25D is a perspective side view of a motion control device piston damper with a pressure relief valve conduit shown with dotted lines.

FIG. 25E is a perspective cross section view of the motion control device piston damper with a pressure relief blockage jam of magnetic particles.

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes a controllable fluid valve for controlling a magnetorheological fluid. The controllable fluid valve preferably includes a magnetorheological fluid flow conduit with a magnetorheological fluid flow path, a north magnetic pole and a south magnetic pole, with the south magnetic pole proximate the north magnetic pole with a gradient producing spacer between the south magnetic pole and the north magnetic pole wherein the south magnetic pole and the north magnetic pole generate a plurality of nontraversing magnetic field flux lines that extend into the magnetorheological fluid flow path.

In an embodiment the invention includes a controllable fluid valve for controlling a magnetorheological fluid. The controllable fluid valve preferably includes a magnetorheological fluid conduit with a magnetorheological fluid path. The controllable fluid valve preferably includes a north magnetic pole and a south magnetic pole, the south magnetic pole proximate the north magnetic pole with a gradient producing spacer between the south magnetic pole and the north magnetic pole preferably with the magnetic spacer forcing a plurality of magnetic flux lines from the north pole out into the magnetorheological fluid path and then back into the south pole.

In an embodiment the invention includes a controllable fluid valve for controlling a magnetorheological fluid. The controllable fluid valve preferably includes a magnetorheological fluid conduit with a magnetorheological fluid path, a north magnetic pole and a south magnetic pole, with the south magnetic pole proximate the north magnetic pole with a nonmagnetic spacer between the south magnetic pole and the north magnetic pole wherein the nonmagnetic spacer forces a plurality of magnetic flux lines from the north pole out into the magnetorheological fluid path and then back into the south pole.

In an embodiment the invention includes a method of controlling magnetorheological fluid flow. The method preferably includes providing a magnetorheological fluid flow conduit with a magnetorheological fluid flow path, the fluid flow path having a fluid flow axis. The method preferably includes providing a north magnetic pole and a south magnetic pole disposed radially from the fluid flow direction along a radially extending line r, with the north magnetic pole spaced from the south magnetic pole along the fluid flow path by a gradient producing spacer. The method preferably includes producing a magnetic field H with the north magnetic pole and the south magnetic pole, the magnetic field H having a magnetic field radial component Hᵣ, wherein the change in the magnetic field radial component relative to the change in radial distance is nonzero.

In an embodiment the invention includes a method of controlling magnetorheological fluid flow. The method preferably includes providing a magnetorheological fluid flow conduit with a magnetorheological fluid flow path. The method preferably includes providing a north magnetic pole and a south magnetic pole, and producing a magnetic field with the north magnetic pole and the south magnetic pole, with the magnetic field extending into the magnetorheological fluid flow path while inhibiting the magnetic field from traversing the magnetorheological fluid flow path.

In an embodiment the invention includes a method of making a magnetorheological fluid flow control valve. The method preferably includes providing a magnetorheological fluid flow conduit with a magnetorheological fluid flow path. The method preferably includes providing a north magnetic pole and a south magnetic pole, and disposing the south magnetic pole proximate the north magnetic pole with a spacer between the south magnetic pole and the north magnetic pole wherein the south magnetic pole and the north magnetic pole generate a nontraversing magnetic field that extends into the magnetorheological fluid flow path.

In an embodiment the invention includes a motion control device. The motion control device preferably includes a magnetorheological fluid path containing a magnetorheological fluid. The motion control device preferably includes a north magnetic pole and a south magnetic pole, the south magnetic pole proximate the north magnetic pole with a spacer between the south magnetic pole and the north magnetic pole wherein the south magnetic pole and the north magnetic pole generate a nontraversing magnetic field that extends into the magnetorheological fluid path.

In an embodiment the invention includes a motion control device. The motion control device preferably includes a magnetorheological fluid path containing a magnetorheological fluid with a device wall. The device preferably includes a north magnetic pole and a south magnetic pole proximate the device wall. Preferably the south magnetic pole is proximate the north magnetic pole with a flux line gradient producer between the south magnetic pole and the north magnetic pole wherein the south magnetic pole and the north magnetic pole generate a plurality of magnetic field flux lines that extends out from the device wall and into the magnetorheological fluid path and provide an area of high field gradient proximate the device wall.

In an embodiment the invention includes a method of controlling magnetorheological fluid flow. The method preferably includes providing an electromagnet. The method preferably includes providing a magnetorheological fluid. The method preferably includes providing a magnetorheological fluid flow conduit with a conduit wall for containing the magnetorheological fluid. Preferably the magnetorheological fluid flow conduit has a magnetorheological fluid flow path along the conduit wall. The method preferably includes producing a magnetic gradient in the magnetorheological fluid proximate the conduit wall with the electromagnet.

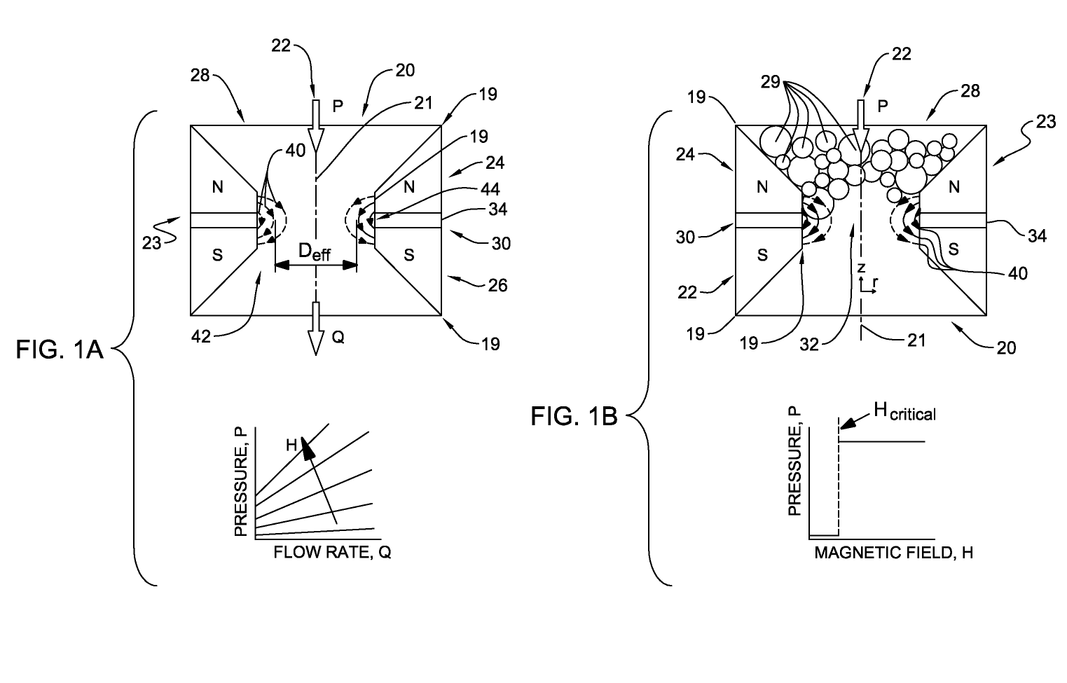

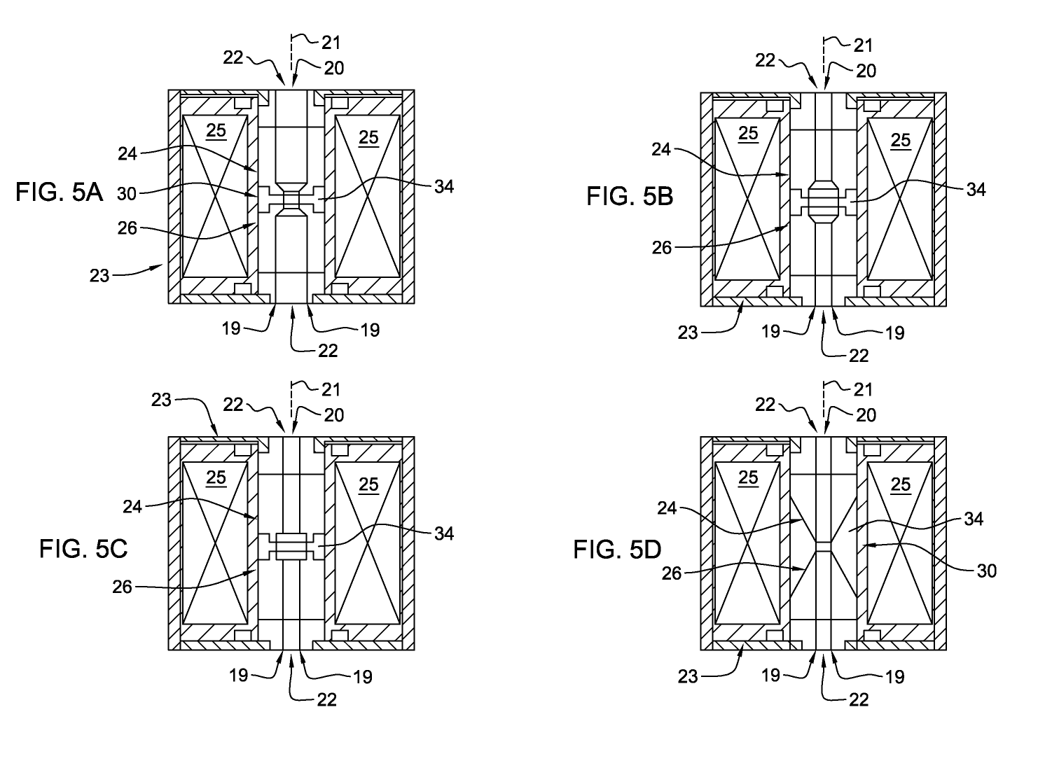

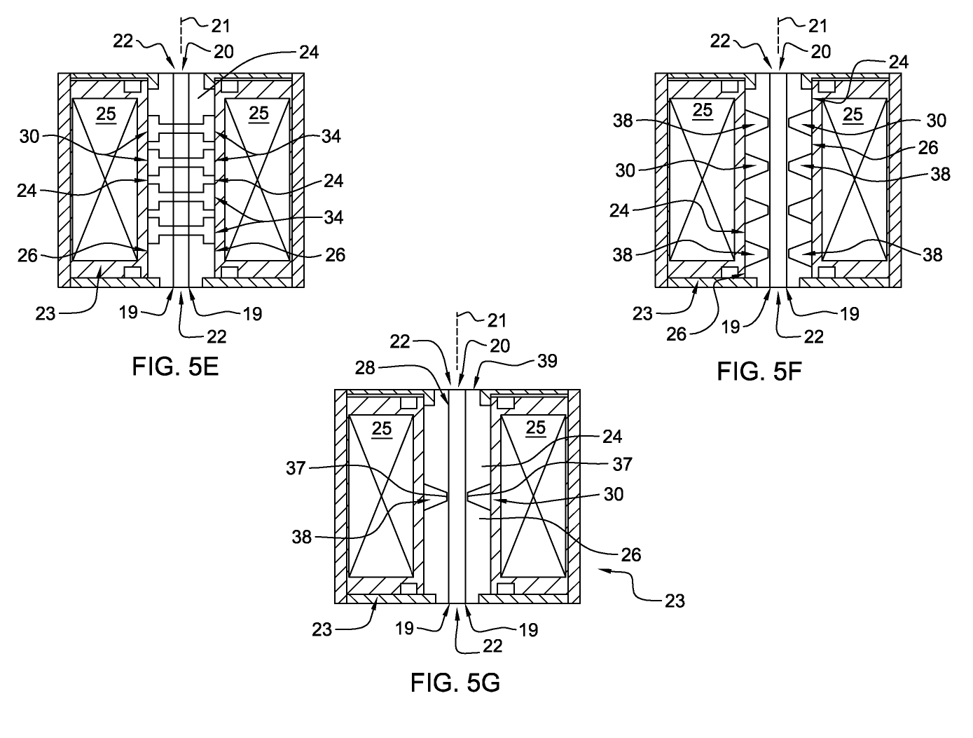

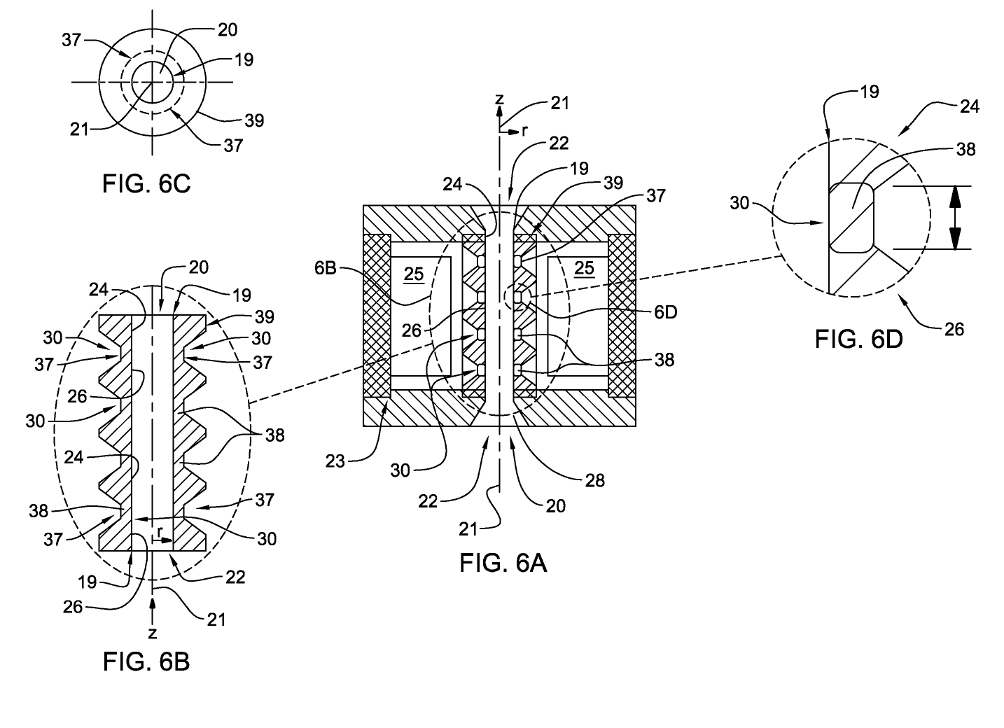

In an embodiment the invention includes a controllable fluid valve for controlling a magnetorheological fluid. The controllable fluid valve preferably includes a magnetorheological fluid flow conduit with a magnetorheological fluid flow path, a north magnetic pole and a south magnetic pole, with the south magnetic pole proximate the north magnetic pole with a gradient producing spacer between the south magnetic pole and the north magnetic pole wherein the south magnetic pole and the north magnetic pole generate a plurality of nontraversing magnetic field flux lines that extend into the magnetorheological fluid flow path. The controllable fluid valve includes a magnetorheological fluid flow conduit 20 with a magnetorheological fluid flow path 22, a north magnetic pole 24 and a south magnetic pole 26, with the south magnetic pole 26 proximate the north magnetic pole 24 with a gradient producing spacer 30 between the south magnetic pole and the north magnetic pole wherein the magnetic poles generate a plurality of nontransversing magnetic field flux lines 40 that extend into the magnetorheological fluid flow path 22. Preferably the spacer 30 is a magnetic discontinuity that separates the poles 24 and 26 generating the flux lines 40. In two preferred embodiments the gradient producing spacer 30 is preferably a magnetic discontinuity nonmagnetic material physical member 34 or a magnetic discontinuity magnetic material member 38 with the magnetic discontinuity created by the shape and dimensions of the magnetic material between the poles. Spacer 30 preferably pushes out magnetic field 42 into the fluid flow 22, preferably with spacer 30 provided to maximize a magnetic field gradient 44 proximate the fluid flow conduit wall 19. Gradient producing spacer 30 preferably produces the magnetic field gradient 44 with magnetic field strength gradient that has a variation from a flow conduit maximum strength to a flow conduit minimum strength in relationship to a fluid flow conduit physical dimension, preferably with the magnetic field strength variation gradient over a conduit physical dimension normal to the flow of magnetorheological fluid in the conduit. Preferably the flow conduit maximum strength is proximate the conduit wall 19 and the flow conduit minimum strength is distal from the conduit wall 19. Preferably the flow conduit maximum strength is proximate the spacer 30 and the flow conduit minimum strength is distal from the spacer 30. Preferably the nontraversing magnetic field in the magnetorheological fluid flow path 22 is nonuniform, with the field gradient 44 having a gradient dHᵣ/dr which is nonzero. In preferred embodiments such as shown in FIG. 1-5(e), 7-12, 15-18C the spacer 30 is comprised of a nonmagnetic spacer 34 with the spacer preferably formed from a nonmagnetic material, preferably a nonmagnetic solid material with the nonmagnetic spacer 34 comprised of a nonmagnetic solid. Preferably the nonmagnetic spacer 34 has a relative magnetic permeability centered about 1. Preferably the spacer 30 is a gradient producing spacer between the two poles with a relative magnetic permeability centered about 1 (1±0.1), preferably with relative permeability in the range from about 0.9 to 1.1 relative to free space (relative to permeability of empty vacuum). Preferably the nonmagnetic material spacer 34 is formed from a material different from the poles, with the nonmagnetic material having a low relative magnetic permeability Mur, preferably 0.9<Mur<1.1. Preferably the spacer has a relative magnetic permeability significantly smaller than that of the magnetic magnetorheological fluid 28. Preferably the spacer relative magnetic permeability is low relative to the poles 24, 26 and the magnetorheological fluid 28 such that the magnetic flux lines 40 prefer to travel through the fluid 28 at the expense of going through the spacer 30. Preferably the nonmagnetic spacer material creates a discontinuity in the permeability of the magnetic circuit such that the magnetic field 42 is forced to bulge into the adjacent magnetorheological fluid flow path. Preferably the nonmagnetic spacer 34 is made from a nonmagnetic physical solid material such as aluminum or plastic, preferably with the solid spacer having the relative magnetic permeability of about 1.0. In preferred embodiments, such as shown in FIGS. 5(f), 5(g) and 6 the spacer 30 is a magnetic material spacer 38. Preferably the magnetic spacer 38 and the poles 24, 26 are formed from the same magnetic material, preferably a magnetic solid metal material, preferably magnetic metal such as low carbon steel, iron containing alloy, or nickel-iron alloy. Preferably as shown in FIG. 6 the spacer 30 is provided by a magnetic conduit gradient member 39 that provides a physical flow conduit wall 19 for containing fluid 28 and shapes the magnetic field in the flow 22, preferably with the magnetic conduit gradient member 39 formed from a uniform homogeneous solid magnetic metal material that is shaped to provide the poles 24, 26 with the spacer 38 separating the poles, with conduit wall 19 a physical solid boundary of the fluid flow conduit 20. Magnetic spacer 38 is formed from a magnetic solid material, preferably a magnetic solid material member with a saturation inducing reduced dimension 37. Preferably with the spacer 38 the reduced dimension 37 provides a magnetic spacer magnetic saturation which forces a plurality of magnetic flux lines 40 from the north pole 24 out into the magnetorheological fluid path 22 and then back into the south pole 26. Preferably magnetic spacer 38 has a high initial relative magnetic permeability (preferably >100) at low magnetic flux density and saturates magnetically at a high flux density. Preferably the magnetic spacer region 38 is formed by a reduced physical dimension 37 that forces the local flux density above the saturation point such that the flux lines 40 are forced out into the adjacent magnetorheological fluid 28. The flow channel elements of magnetic conduit gradient member 39 are preferably formed from a magnetic ferrous metal material such as low carbon steel, a nickel alloy, or ferrite material. In a preferred embodiment the magnetic spacer material 38 is a nickel iron alloy. The magnetic material magnetic spacer 38 has a low saturation point relative to the adjacent poles 24,26, preferably with a relatively reduced physical dimension 37 compared with the physical dimensions of the adjacent poles 24,26. Preferably the magnetic spacer 38 has a high initial permeability with low saturation flux density, preferably with the saturating spacer 38 formed from a magnetic material such that the spacer 38 becomes saturated when an increased current is supplied to the electromagnetic coil 25. Preferably the magnetorheological fluid flow conduit 20 has a fluid flow path center axis 21 and the nontraversing magnetic field lines 40 do not extend beyond the fluid flow path center axis 21. In preferred embodiments the magnet poles 24, 26 are on outer perimeter of the conduit 20, magnetic field lines 40 extending out from the north pole 24 towards the center axis 21 and then back to south pole 26, with the flux lines 40 bumped out around the separating thickness of the spacer 30 forming the magnetic gradient 44 in the magnetorheological fluid 28. Preferably the magnetorheological fluid 28 includes a plurality of magnetic particle sizes 29 wherein the magnetic field gradient 44 in the magnetorheological fluid flow path 22 collects the plurality magnetic particle sizes 29 into a fluid flow jam blockage 32. Preferably the magnetorheological fluid 28 plurality of magnetic particle sizes 29 have a jamming particle size distribution, preferably with particle size diameters in a range from about 0.1 to 500 microns, with the fluid flow jam blockage 32 substantially blocking the conduit 20 and fluid flow 22 proximate the poles 24, 26 and spacer 30 with the gradient field 44. Preferably the range of particle sizes 29 jams the fluid flow with blockage 32, prefer with the range including at least about 100 microns, preferably with particles with a diameter from about 5 to 100 microns, preferably a median particle distribution of 50 (D50). Preferably the magnetorheological fluid 28 includes magnetic particle sizes above 50 microns, and below 50 microns. Preferably with a jamming current supplied to the electromagnetic coil the magnetic field gradient provides a magnetic field H_{critical} that collects the plurality magnetic particle sizes 29 into the fluid flow jam blockage 32, such as shown in FIG. 1B. Preferably the controllable fluid valve provides a magnetorheological fluid pressure P (kPa) and a magnetorheological fluid flow rate Q (cm³/sec), with the change in the magnetorheological fluid pressure relative to the change in magnetorheological fluid flow rate increasing as the applied magnetic field H increases, such as shown in FIG. 1A. Preferably the magnetorheological fluid pressure relative to flow rate is a function of the electromagnetic coil applied current and the produced magnetic field strength. Preferably the slope of pressure versus flow rate increases with an increased current supply to the EM coil generating the applied magnetic field (slope increases with increased current supplied to EM coil). Preferably the controllable fluid valve includes the electromagnetic coil 25, with the electromagnetic coil supplied with a variable current wherein the rate of change in magnetorheological fluid pressure P (kPa) relative to magnetorheological fluid flow rate Q (cm³/sec) is nonzero as the variable current is varied. In preferred embodiments the invention includes multiple parallel flow conduit channels 20 and/or multiple sequential spacers 30 on the same flow channel conduit 20.

In an embodiment the invention includes a controllable fluid valve for controlling a magnetorheological fluid. The controllable fluid valve preferably includes a magnetorheological fluid conduit with a magnetorheological fluid path. The controllable fluid valve preferably includes a north magnetic pole and a south magnetic pole, the south magnetic pole proximate the north magnetic pole with a gradient producing spacer between the south magnetic pole and the north magnetic pole wherein the spacer forces a plurality of magnetic flux lines from the north pole out into the magnetorheological fluid path and then back into the south pole.

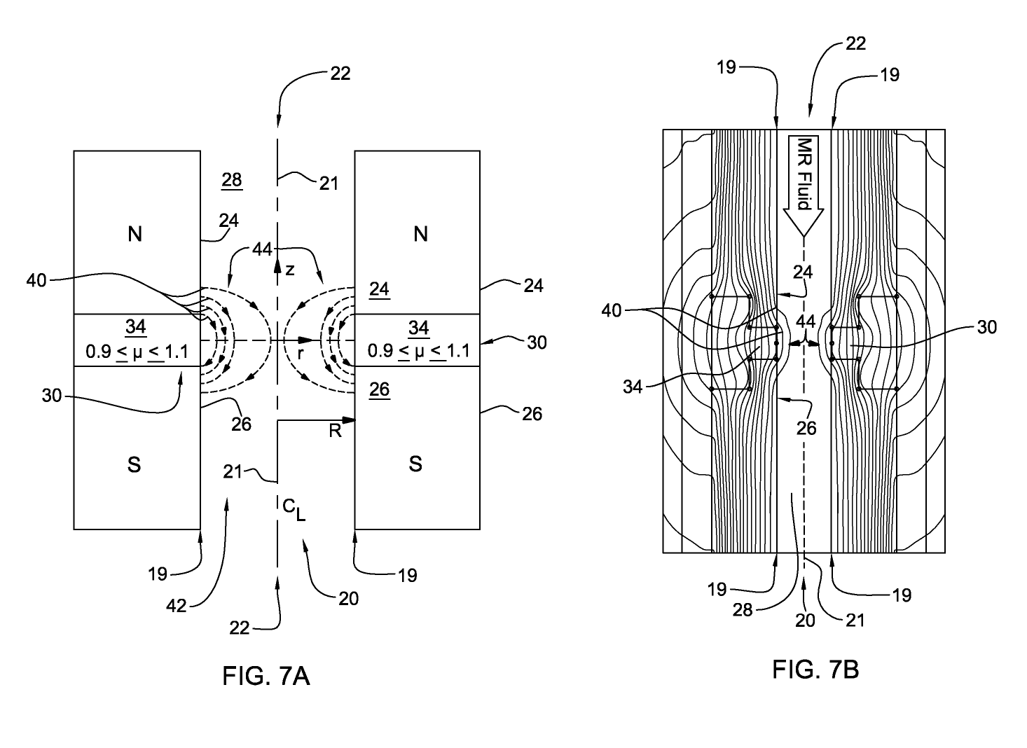

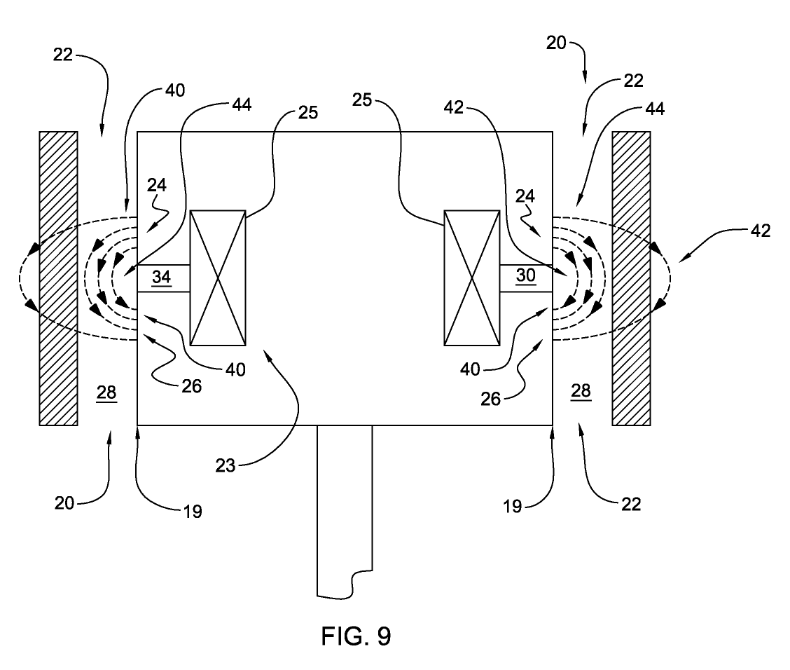

The controllable fluid valve for controlling magnetorheological fluid 28 includes magnetorheological fluid conduit 20 with magnetorheological fluid path 22. Preferably the valve includes north magnetic pole 24 and south magnetic pole 26, with the south magnetic pole proximate the north magnetic pole with a magnetic fluid gradient producing spacer 30 between the south magnetic pole and the north magnetic pole wherein the magnetic spacer forces a plurality of magnetic flux lines 40 from the north pole out into the magnetorheological fluid path 22 and then back into the south pole. Preferably the gradient producing magnetic spacer is a magnetic solid material spacer 38 with the magnetic saturation forced out flux lines 40 producing magnetic gradient 44 in the fluid 28. Preferably the magnetorheological fluid conduit 20 includes a longitudinal length conduit wall 19 and a fluid flow path center 21, with the fluid flow path center 21 distal from the conduit wall 19. Preferably the north pole 24, the magnetic spacer 38, and the south pole 26 are proximate the conduit wall 19 with the magnetic spacer directing the flux lines 40 out towards the path center 21, preferably with the spacer separating the north and south poles such that flux lines form gradient magnetic field 44 proximate the wall 19. Preferably the magnetic spacer 38 creates a discontinuity in the permeability of the magnetic circuit as the applied current to the EM coil 25 is increased such that the magnetic field 42 is forced to bulge into the adjacent magnetorheological fluid flow path 22. In preferred embodiments, such as shown in FIGS. 5(f), 5(g) and 6 the magnetic material spacer 38, and the poles 24, 26 are formed from the same magnetic material, preferably a magnetic solid metal material, preferably magnetic metal such as low carbon steel, iron containing alloy, or nickel-iron alloy. Preferably as shown in FIG. 6 the spacer 30 is provided by a magnetic conduit gradient member 39 that provides a physical flow conduit wall 19 for containing fluid 28 and shapes the magnetic field in the flow 22, preferably with the magnetic conduit gradient member 39 formed from a uniform homogeneous solid magnetic metal material that is shaped to provide the poles 24, 26 with the spacer 38 separating the poles, with conduit wall 19 a physical solid boundary of the fluid flow conduit 20. Magnetic spacer 38 is formed from a magnetic solid material, preferably by providing the magnetic solid material member with a saturation inducing reduced dimension 37. Preferably with the spacer 38 the reduced dimension 37 provides a magnetic spacer magnetic saturation which forces a plurality of magnetic flux lines 40 from the north pole 24 out into the magnetorheological fluid path 22 and then back into the south pole 26. Preferably magnetic spacer 38 has a high initial relative magnetic permeability (preferably >100) at a low magnetic flux density and saturates magnetically at a high flux density. Preferably the magnetic spacer region 38 is formed by a reduced physical dimension 37 that forces the local flux density above the saturation point such that the flux lines 40 are forced out into the adjacent magnetorheological fluid 28. The flow channel elements of magnetic conduit gradient member 39 are preferably formed from a magnetic ferrous metal material such as low carbon steel, a nickel alloy, or ferrite material. In a preferred embodiment the magnetic spacer material 38 is a nickel iron alloy. The magnetic material magnetic spacer 38 has a low saturation point relative to the adjacent poles 24,26, preferably with a relatively reduced physical dimension 37 compared with the physical dimensions of the adjacent poles 24,26. Preferably the magnetic spacer 38 has a high initial permeability with low saturation flux density, preferably with the saturating spacer 38 formed from a magnetic material such that the spacer 38 becomes saturated when an increased current is supplied to the electromagnetic coil 25. Preferably the magnetic spacer and adjacent magnetic poles are formed from a single piece of homogeneous magnetic material that has a high initial relative magnetic permeability >100 and low saturation flux density. The magnetic spacer region 38 is formed by the applied saturating EM coil current and the reduced physical dimension that forces the local flux density above the saturation point. Preferably the flow channel elements of the magnetic conduit gradient member 39 are formed from a ferrous material such as a low carbon steel, a nickel alloy, or ferrite material. Preferably the gradient producing spacer is formed from the magnetic material, with the magnetic spacer 38 having a low saturation point relative to the adjacent poles 24, 26, preferably with the relatively reduced physical dimension 37 compared with the adjacent poles 24,26. Preferably the magnetic spacer 38 has a high initial permeability with a low saturation flux density, preferably with the poles and spacer formed from the same magnetic metal with physical dimensions varied to provide the spacer 38. Preferably the controllable fluid valve provides a magnetorheological fluid pressure P (kPa) and a magnetorheological fluid flow rate Q (cm³/sec), with the change in the magnetorheological fluid pressure relative to the change in magnetorheological fluid flow rate increasing as the supplied current to EM coil is increased and the applied magnetic field H increases. Preferably the slope of P/Q increases with an increased current supplied to the EM coil. In preferred embodiments magnetic spacers 38 are utilized with multiple flow conduit channels 20 and/or multiple sequential spacers 38 are utilized in series on the same flow channel conduit 20. Preferably the magnetorheological fluid conduit 20 includes longitudinally extending conduit wall 19 and longitudinally extending fluid flow path center 21, with the fluid flow path center radially spaced from the conduit wall with a radial distance (r) wherein the flux lines 40 provide magnetic field gradient 44 having a component of the magnitude (Hr) that changes along the radial distance r. Preferably the magnitude increase from a low magnitude proximate the fluid flow path center to a high magnitude proximate the conduit wall. In embodiments the conduit wall can be a damper piston head side wall or a damper housing wall distal from the damper piston head. Preferably in an embodiment with an exo-toroidal magnetic field, such as an exo-toroidal damper piston head inside an outer damper tubular housing as shown in FIG. 9, the magnitude increase from a low magnitude proximate the outer damper tubular housing wall to higher magnitudes as one moves from this outer damper tubular housing wall inward towards the damper piston head with the gradient producing spacer 30. Preferably with embodiments with an open center orifice and an endo-toroidal magnetic field, such as an endo-toroidal open center circular orifice valve configuration as shown in FIG. 7, the open center orifice valve has a gradient low magnitude minimum at the center of the flow path. In preferred embodiments of the controllable valves and motion control devices, the maximum high magnetic magnitude occurs at the physical solid wall of the valve conduit wall, with the physical solid wall of the valve conduit preferably the damper piston head or the side of the valve conduit wall. Preferably the spacer 38 separates the north and south pole such that the flux lines form gradient magnetic field 44 proximate the wall, with the magnetic field strengthening as one moves from the path center radially towards the wall. Preferably the spacer 38 produces nontraversing magnetic field flux lines 40 that do not traverse the fluid flow conduit 20 and the fluid flow path 22. Preferably the fluid flow path 22 flows the fluid 28 along conduit longitudinal length fluid flow path center axis z direction, with the conduit radial r direction normal to the z axis with r radially extending from fluid flow path center axis 21outward towards the poles and spacer 38. Preferably the magnetic spacer 38 provides a change in the magnetic radial field relative to a change in radial distance such that the magnetic gradient dHᵣ/dr is nonzero. Preferably magnetic spacer 38 provides nontraversing magnetic field flux lines 40 in the magnetorheological fluid flow path 22, with the nontransverse magnetic field 44 in the magnetorheological fluid flow path nonuniform (gradient dHᵣ/dr is nonzero). Preferably the magnetorheological fluid flow conduit 20 has fluid flow path center axis 21 and the flux lines 40 do not extend beyond the fluid flow path center axis 21. Preferably the nontraversing magnetic field does not extend beyond the fluid flow path center axis 21, preferably with the magnet poles 24, 26 on the outer perimeter of symmetrical conduit 20, with magnetic field lines 40 extending out from north pole 24 towards the center axis 21 and then back to south pole 26, such that the flux lines are bumped out around the separating thickness of the spacer 38. Preferably the magnetorheological fluid 28 includes a plurality of magnetic particles with a plurality of sizes 29 wherein the flux lines 40 extending into the magnetorheological fluid flow path 22 collect the plurality of magnetic particles into a fluid flow blockage 32 that substantially blocks the conduit and fluid flow proximate the poles 24,26 and spacer 38. Preferably magnetorheological fluid particle sizes have a range of about 100 microns, preferably with particle diameters in a diameter range from about 5 to 100 microns, preferably with a median particle distribution of 50 (D50). Preferably fluid 28 includes magnetic particle sizes above 50, and below 50 microns.

In an embodiment the invention includes a controllable fluid valve for controlling a magnetorheological fluid. The controllable fluid valve preferably includes a magnetorheological fluid conduit with a magnetorheological fluid path, a north magnetic pole and a south magnetic pole, with the south magnetic pole proximate the north magnetic pole with a nonmagnetic spacer between the south magnetic pole and the north magnetic pole wherein the nonmagnetic spacer forces a plurality of magnetic flux lines from the north pole out into the magnetorheological fluid path and then back into the south pole. Preferably the controllable fluid valve includes magnetorheological fluid conduit 20 with a magnetorheological fluid path 22, north magnetic pole 24 and south magnetic pole 26 with the south magnetic pole 26 proximate the north magnetic pole 24 with gradient producing nonmagnetic spacer 34 between the poles wherein the nonmagnetic spacer 34 forces magnetic flux lines 40 from the north pole 24 out into the magnetorheological fluid path 22 and then back into the south pole 26. Preferably the protruding magnetic flux lines 40 produce a nontraversing magnetic field 44 in the magnetorheological fluid path 22, with the nontraversing magnetic field is nonuniform and having a magnetic gradient dHᵣ/dr that is nonzero. Preferably the nonmagnetic spacer 34 has a relative magnetic permeability centered about 1 (1±0.1), preferably with the spacer made from a material with a relative permeability of about 0.9 to 1.1 relative to empty vacuum space. Preferably the nonmagnetic spacer 34 is formed from a nonmagnetic material having a low relative magnetic permeability Mu, preferably with 0.9<Mu<1.1. Preferably the spacer 34 has a relative magnetic permeability significantly smaller than that of the magnetic magnetorheological fluid 28. Preferably the spacer's relative magnetic permeability is low relative to the poles 24, 26 and the magnetorheological fluid 28 such that the magnetic flux lines 40 will prefer to travel through the fluid 28 at the expense of going through the spacer material. Preferably the nonmagnetic spacer 34 creates a discontinuity in the permeability of the controllable magnetic circuit produced by the EM coil 25 such that the magnetic field is forced to bulge into the adjacent magnetorheological fluid flow path. Preferably the spacer is made from a nonmagnetic solid material such as aluminum or plastic, preferably with a relative magnetic permeability of about 1.0. Preferably the magnetorheological fluid conduit 20 has a fluid flow path center axis 21 with the magnetic flux lines 40 not extending beyond the fluid flow path center axis 21. Preferably with the magnet poles 24, 26 on the outer perimeter of conduit 20, the magnetic field lines 40 extend out from north pole 24 towards the center axis 21 and then back to south pole 26, with the bumped out lines around the separating thickness of the spacer 34 providing the magnetic gradient 44. Preferably the magnetorheological fluid 28 includes a plurality of magnetic particles 29 wherein the nontraversing magnetic field 44 extending into the magnetorheological fluid flow path 22 collects the magnetic particles into a jammed fluid flow blockage 32. Preferably the nonmagnetic spacer 34 produces the magnetic gradient with magnetic field strength H_{critical} which substantially blocks conduit 20 and fluid flow 22 proximate the poles 24, 26 and spacer 34. Preferably the range of particle sizes 29 jams the fluid flow, preferably with the sizes having a range of about 100 microns, prefer with particle diameter ranges from about 5 to 100 microns, preferably with a median particle distribution of 50 (D50). Preferably magnetorheological fluid 28 includes particle sizes above 50 microns and below 50 microns.

In an embodiment the invention includes a method of controlling magnetorheological fluid flow. The method preferably includes providing a magnetorheological fluid flow conduit with a magnetorheological fluid flow path, the fluid flow path having a fluid flow axis. The method preferably includes providing a north magnetic pole and a south magnetic pole disposed radially from the fluid flow axis along a radially extending line r, with the north magnetic pole spaced from the south magnetic pole along the fluid flow path by a gradient producing spacer. The method preferably includes producing a magnetic field H with the north magnetic pole and the south magnetic pole, the magnetic field H having a having a magnetic field radial component Hᵣ, wherein the change in the magnetic field radial component relative to the change in radial distance is nonzero.

Controlling magnetorheological fluid 28 flow preferably includes providing a magnetorheological fluid flow conduit 20 with a magnetorheological fluid flow path 22. Preferably the fluid flow path 22 has a fluid flow axis 21 extending in the z direction. Preferably at least a first north magnetic pole 24 and at least a first south magnetic pole 26 are disposed radially from the fluid flow axis 21 along a radially extending line r direction (with r normal to z). The north magnetic pole 24 is axially disposed and spaced from the south magnetic pole 26 along the fluid flow path 22 with a gradient producing spacer 30. The method includes producing a nontraversing magnetic field H with the north magnetic pole 24 and the south magnetic pole 26, with the produced magnetic field H having a having a magnetic field radial component Hᵣ wherein dHᵣ/dr≠0. Preferably a magnetic gradient is produced in the magnetorheological fluid that has a change in magnetic radial field relative to change in radial distance that is nonzero, preferably with the nonzero gradient dHᵣ/dr controlling the flow of fluid through the conduit. Preferably the produced magnetic field has a component H_{z} along the flow axis between poles 24, 26. Preferably the produced field has a radial component Hᵣ and an axial component H_{z}, with both dHᵣ/dr≠0 and dH_{z}/dz≠0. Preferably the produced field has a radial component (Hᵣ) and a component along the flow path (H_{z}) with both dHᵣ/dr≠0 and dH_{z}/dz≠0, preferably with dHᵣ/dz≠0 and dH_{z}/dr≠0. Preferably the north magnetic pole 24 is disposed proximate the south magnetic pole 26. In a preferred embodiment the gradient producing spacer 30 is a nonmagnetic solid 34. In a preferred embodiment the gradient producing spacer 30 is a magnetic solid spacer 38, preferably with the method including forming the poles and the spacer from a magnetic metal material. Preferably forming the magnetic spacer 38 includes reducing a physical dimension 37 of the magnetic material, preferably with the magnetic spacer 38 having a spacer predetermined reduced dimension 37 relative to the north pole and south pole predetermined larger dimension.

In an embodiment the invention includes a method of controlling magnetorheological fluid flow. The method preferably includes providing a magnetorheological fluid flow conduit with a magnetorheological fluid flow path. The method preferably includes providing a north magnetic pole and a south magnetic pole, and producing a magnetic field with the north magnetic pole and the south magnetic pole, with the magnetic field extending into the magnetorheological fluid flow path while inhibiting the magnetic field from traversing the magnetorheological fluid flow path. Preferably the method includes providing a magnetorheological fluid flow conduit 20 with magnetorheological fluid flow path 22. Preferably the method includes providing north magnetic pole 24 and south magnetic pole 26. Preferably the method includes producing a nontraversing magnetic field 44 with the north magnetic pole 24 and the south magnetic pole 26, with the magnetic field extending into the magnetorheological fluid flow path 22 while inhibiting the magnetic field lines 40 from traversing the magnetorheological fluid flow path. Preferably the north magnetic pole 24 is disposed proximate the south magnetic pole 26. Preferably the north magnetic pole 24 is separated from the south magnetic pole 26 with a gradient producing spacer 30. In an embodiment the gradient producing spacer 30 is a nonmagnetic spacer 34. In an embodiment the gradient producing spacer 30 is a magnetic spacer 38. In an embodiment the method includes producing a plurality of magnetic field gradients along the fluid flow path 22. In an embodiment the method includes jamming the fluid conduit with a gradient produced blockage, preferably with a magnetic field H_{critical} produced by supplying a critical current to the EM coil 25. In an embodiment the method includes producing and controlling a magnetic fluid gradient to provide a fluid flow conduit valve orifice with a controllable effective diameter D_{eff}, preferably an open center circular orifice valve with a controllable effective diameter D_{eff} such as shown in FIG. 1A. In an embodiment the method includes supplying EM coil 25 with an increasing current with the slope of pressure/flowrate (P/Q) increasing with the increased current.

In an embodiment the method includes controlling magnetorheological fluid flow in a damper, preferably with the conduit 20 between a damper piston and an outer damper housing wall or with the conduit in piston head. In an embodiment the method includes providing a plurality of flow conduits 20 in a piston. In an embodiment the method includes controlling magnetorheological fluid flow in an energy dissipation device, preferably by controlling the release of controlling magnetorheological fluid from a steering column crash force mitigation device. In an embodiment the method includes controlling magnetorheological fluid flow in rotary coupler, preferably by controlling the flow of fluid in a roll bar rotary coupler device. In an embodiment the method includes controlling magnetorheological fluid flow in a motion control device to control motion.

In an embodiment the invention includes a method of making a magnetorheological fluid flow control valve. The method preferably includes providing a magnetorheological fluid flow conduit with a magnetorheological fluid flow path. The method preferably includes providing a north magnetic pole and a south magnetic pole, and disposing the south magnetic pole proximate the north magnetic pole with a spacer between the south magnetic pole and the north magnetic pole wherein the south magnetic pole and the north magnetic pole generate a nontraversing magnetic field that extends into the magnetorheological fluid flow path. Preferably the method includes providing a magnetorheological fluid flow conduit 20 with a magnetorheological fluid flow path 22. Preferably the method includes providing north magnetic pole 24 and south magnetic pole 26. Preferably the method includes disposing the south magnetic pole 26 proximate the north magnetic pole 24 with a spacer 30 between the poles wherein the magnetic poles generate a nontraversing magnetic field with flux lines 40 that extends into the magnetorheological fluid flow path 22. Preferably the magnetic field does not traverse the fluid flow conduit 20 and the fluid flow path 22. Preferably the method includes positioning the south magnetic pole and the north magnetic pole proximate the magnetorheological fluid flow conduit 20 and inhibiting the magnetic field flux lines 40 from traversing the magnetorheological fluid flow path 22. Preferably the north magnetic pole 24 is separated from the south magnetic pole 26 with a gradient producing spacer 30, in an embodiment the gradient producing spacer 30 is a nonmagnetic spacer 34 and in another embodiment the gradient producing spacer 30 is a magnetic spacer 38. In an embodiment the method includes producing a plurality of magnetic field gradients along the fluid flow path 22. In an embodiment the method includes jamming the fluid conduit with a gradient produced blockage, preferably with a magnetic field H_{critical} produced by supplying a critical current to the EM coil 25. In an embodiment the method includes producing and controlling a magnetic fluid gradient to provide a fluid flow conduit valve orifice with a controllable effective diameter D_{eff}. In an embodiment the method includes supplying EM coil 25 with an increasing current with the slope of pressure/flowrate (P/Q) increasing with the increased current. In an embodiment the method includes controlling magnetorheological fluid flow in a damper, preferably with the conduit 20 between a damper piston and an outer damper housing wall or with the conduit in piston head. In an embodiment the method includes providing a plurality of flow conduits 20 in a piston. In an embodiment the method includes controlling magnetorheological fluid flow in an energy dissipation device, preferably by controlling the release of controlling magnetorheological fluid from a steering column crash force mitigation device. In an embodiment the method includes controlling magnetorheological fluid flow in rotary coupler, preferably by controlling the flow of fluid in a roll bar rotary coupler device. In an embodiment the method includes controlling magnetorheological fluid flow in a motion control device to control motion.

In an embodiment the invention includes a motion control device. The motion control device preferably includes a magnetorheological fluid path containing a magnetorheological fluid. The motion control device preferably includes a north magnetic pole and a south magnetic pole, the south magnetic pole proximate the north magnetic pole with a spacer between the south magnetic pole and the north magnetic pole wherein the south magnetic pole and the north magnetic pole generate a nontraversing magnetic field that extends into the magnetorheological fluid path.

The motion control device includes of magnetorheological fluid path 22 containing magnetorheological fluid 28. The device includes north magnetic pole 24 and south magnetic pole 26, with the south magnetic pole 26 proximate the north magnetic pole 24 with spacer 30 between the south magnetic pole and the north magnetic pole wherein the south magnetic pole and the north magnetic pole generate a nontraversing magnetic field that extends into the magnetorheological fluid path 22. Preferably the magnetic field flux lines 40 do not traverse the fluid flow conduit 20 and the fluid flow path 22.

In an embodiment the invention includes a motion control device. The motion control device preferably includes a magnetorheological fluid path containing a magnetorheological fluid with a device wall. The device preferably includes a north magnetic pole and a south magnetic pole proximate the device wall. Preferably the south magnetic pole is proximate the north magnetic pole with a flux line gradient producer between the south magnetic pole and the north magnetic pole wherein the south magnetic pole and the north magnetic pole generate a plurality of magnetic field flux lines that extends out from the device wall and into the magnetorheological fluid path and provide an increased magnetic field gradient proximate the device wall. Preferably the motion control device includes magnetorheological fluid path 22 containing magnetorheological fluid 28 with a device wall 19. The device includes north magnetic pole 24 and south magnetic pole 26 proximate the device wall 19, with the south magnetic pole 26 proximate the north magnetic pole 24 with a flux line gradient producer 30 between the south magnetic pole 26 and the north magnetic pole 24 wherein the magnetic poles generate a plurality of magnetic field flux lines 40 that extends out from the device wall 19 and into the magnetorheological fluid path 22 and provide an increased magnetic field gradient 44 proximate the device wall 19. Preferably the nontraversing magnetic field 42 does not traverse the fluid flow conduit 20 and the fluid flow path 22, preferably the flux lines 40 do not extend out into a distal magnetic solid device member, such as an opposing magnetic wall or other solid device component that has a high magnetic permeability. Preferably the device wall is a solid that assists in the confinement of the magnetorheological fluid 28, and in an embodiment the device wall is the conduit wall, and in an embodiment the device wall is a wall of a piston head, and in an embodiment the device wall is a wall of a moving component adjacent the magnetorheological fluid 28.

In an embodiment the invention includes a method of controlling magnetorheological fluid flow. The method preferably includes providing an electromagnet. The method preferably includes providing a magnetorheological fluid. The method preferably includes providing a magnetorheological fluid flow conduit with a conduit wall for containing the magnetorheological fluid. Preferably the magnetorheological fluid flow conduit has a magnetorheological fluid flow path along the conduit wall. The method preferably includes producing a magnetic gradient in the magnetorheological fluid proximate the conduit wall with the electromagnet. The method includes providing an electromagnet, preferably an electromagnet 23 with an electromagnetic coil 25 and poles 24, 26. The method includes providing magnetorheological fluid 28. The method includes providing a magnetorheological fluid flow conduit 20 with a conduit device wall 19 for containing the magnetorheological fluid 28. The magnetorheological fluid flow conduit preferably has a magnetorheological fluid flow path 22 along the conduit wall 19. The method includes producing a magnetic gradient 44 in the magnetorheological fluid 28 proximate the conduit wall 19 with the electromagnet 23. Preferably the method includes making controllable fluid valves by spacing magnetic poles 24, 26 axially along the flow path 22 to generate a magnetic field gradient 44 that interacts with the magnetorheological fluid 28. Preferably the method includes making a magnetorheological fluid valve in which the controllability of the valve is caused by the fluid's interaction with a nonuniform magnetic field 44, with a spacing of the poles producing a gradient 44 with pushed out flux lines to control the flow of magnetorheological fluid 28 proximate the poles 24, 26.

In preferred embodiments, the invention includes generating a nonuniform magnetic field in the magnetorheological fluid 28 in the conduit 20 proximate the electromagnet 23, preferably with the electromagnet generated nonuniform magnetic field controlling the flow of the magnetorheological fluid 28 in the nonuniform magnetic field.

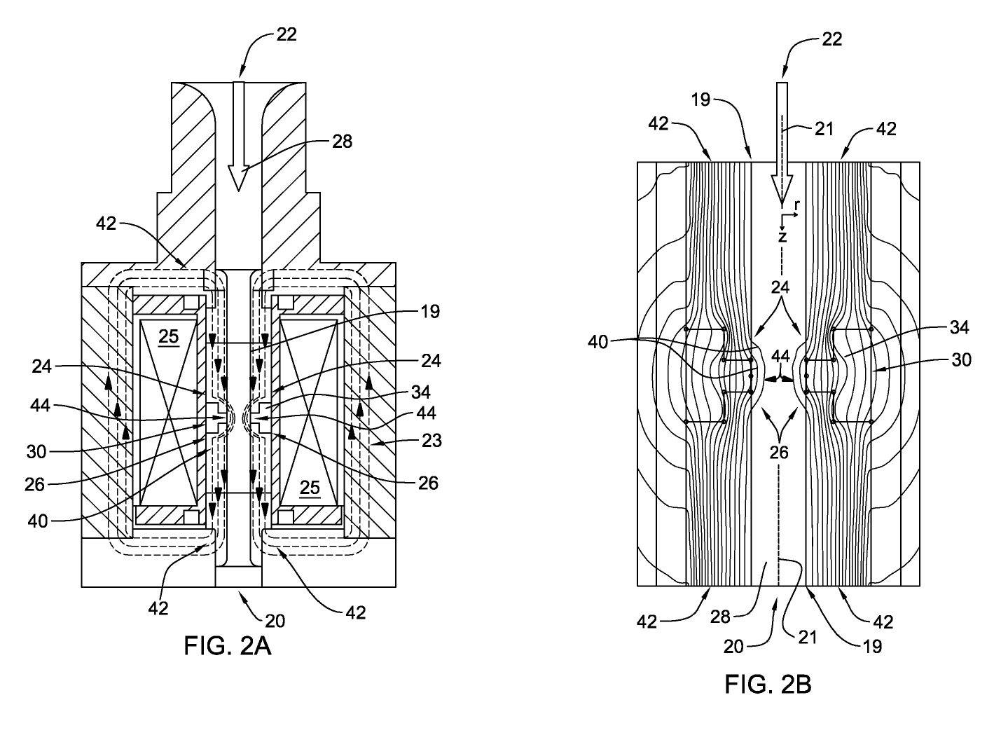

In a preferred embodiment such as shown in FIG. 1A, the electromagnet generated nonuniform magnetic field controls the flow of the magnetorheological fluid 28 through a conduit orifice, preferably a circular orifice, preferably with the poles and spacer having narrowing conduit walls providing funneled sloped walls proximate the poles, with the electromagnet generated and controlled strong and highly nonuniform magnetic field providing the magnetic field gradient in the fluid in the conduit orifice. Preferably the electromagnet generated highly nonuniform magnetic field controls the fluid flow through the orifice conduit, preferably pinching the fluid while inhibiting solidifying the fluid throughout the valve orifice conduit and producing a jammed blockage, the nonuniform field controls fluid flow while solidifying the magnetorheological fluid proximate the device walls of the valve orifice conduit, preferably with the nonuniform magnetic field strength controlling the inward distance that such solidification occurs to effectively control the orifice diameter (D_{eff}). In a preferred embodiment such as shown in FIG. 1B, the electromagnet generated nonuniform magnetic field controls the flow of the magnetorheological fluid 28 through a conduit orifice, preferably a circular orifice, preferably with the poles and spacer having narrowing conduit walls providing funneled sloped walls proximate the poles, with the electromagnet generated and controlled strong and highly nonuniform magnetic field providing the magnetic field gradient in the fluid in the conduit orifice to provide a controlled jamming of the magnetorheological fluid magnetic iron particles 29, with the controlled jamming of the particles in the conduit orifice preferably reversible, with flow of particles 29 and the fluid returning after current to the electromagnetic coil is reduced below a critical level. In a preferred embodiment such as shown in FIG. 2, the strong magnetic field gradient is produced with the electromagnet with the spacer diverted flux path controlling the fluid flow through the conduit valve, with the left side FIG. 2A showing the cross section of the controllable valve components with the flux path lines shown as dashed and the right side FIG. 2B showing a finite element model of a gradient field embodiment of the invention.

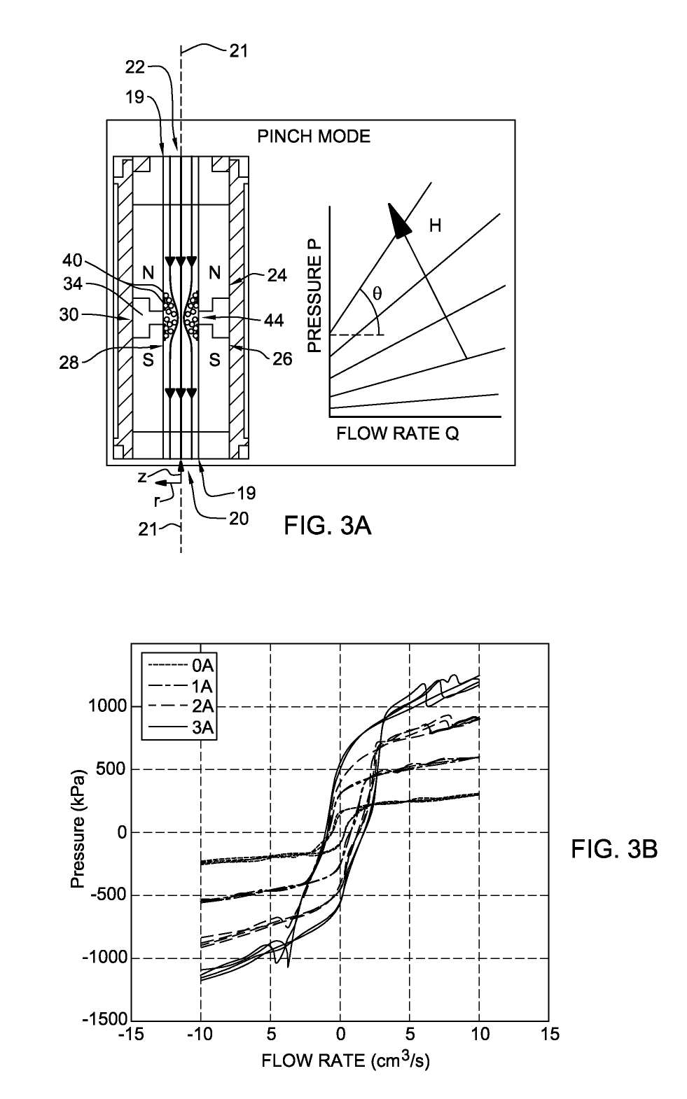

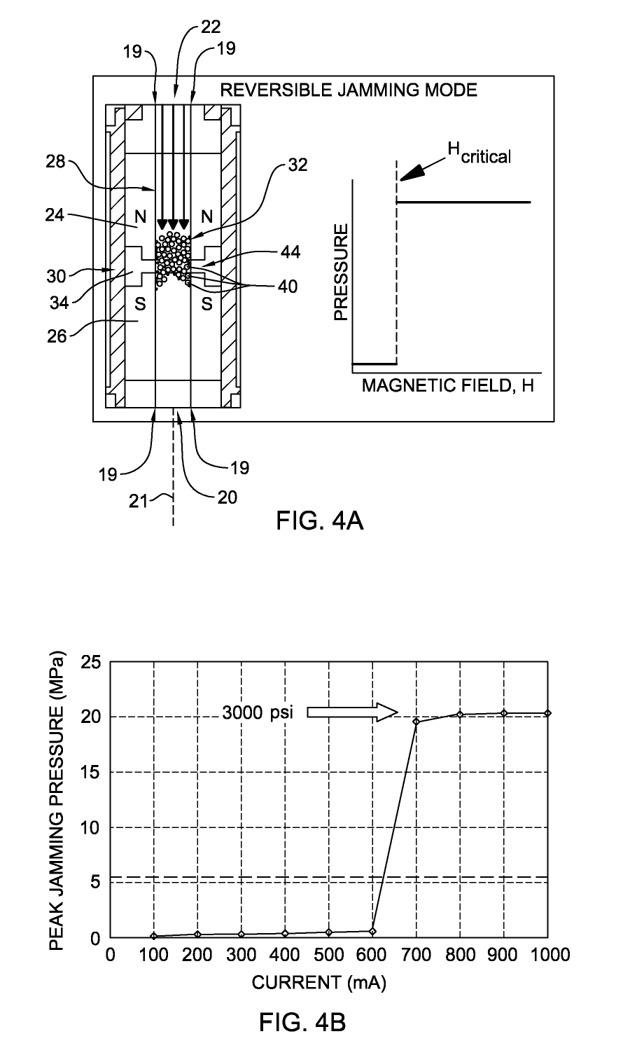

In a preferred embodiment such as shown in FIG. 3, the electromagnet generated nonuniform magnetic field controls the flow of the magnetorheological fluid 28 through a conduit orifice with a pinching of the effective diameter of the circular conduit with the controllable effective diameter orifice proximate the spacer 30, with the plots showing the increasing slope as the current supplied to the EM coil is increased to provide a smaller magnetically pinched orifice diameter (D_{eff}) for fluid flow. In a preferred embodiment such as shown in FIG. 4, the electromagnet generated nonuniform magnetic field controls the flow of the magnetorheological fluid 28 through a conduit orifice with a jamming of the flow with the blockage 32, with the plots showing a dramatic rise in pressure when the current supplied to the electromagnet reaches I_{critical} (H_{critical} magnetic reversible jamming field). In preferred embodiments such as shown in FIG. 4, the methods include providing a minimal critical current level to the electromagnet to produce a reversible jamming pressure, preferably with a reversible jamming pressure of at least 1,000 psi, preferably at least 2,000 psi, preferably at least 2,500 psi (about 3000 psi peaked jamming pressure). In preferred embodiments such as shown in FIG. 4, the methods include providing a minimal critical current level to the electromagnet to produce a reversible jamming pressure, preferably with a reversible jamming pressure of at least 10 MPa, preferably at least 15 MPa, preferably at least 17 MPa, preferably at least 19 MPa (about 20 MPa peak jamming pressure). In a preferred embodiment such as shown in FIG. 5A cross-section view, the strong magnetic field gradient is produced with the electromagnet with the spacer diverted flux path controlling the fluid flow through the conduit valve with the fluid flow conduit proximate the poles having a bottleneck valve wall with narrowing conduit walls with the walls sloping towards the fluid flow path center. In a preferred embodiment such as shown in FIG. 5B cross-section view, the strong magnetic field gradient is produced with the electromagnet with the spacer diverted flux path controlling the fluid flow through the conduit valve with the fluid flow conduit proximate the poles having a reverse bottleneck valve wall with widening conduit walls with the walls sloping away from the fluid flow path center.

In a preferred embodiment such as shown in FIG. 5C cross-section view, the strong magnetic field gradient is produced with the electromagnet with the spacer diverted flux path controlling the fluid flow through the conduit valve with the fluid flow conduit proximate the poles having a straight walled larger diameter cavity valve with conduit walls parallel with the fluid flow path center having an enlarged conduit dimension.

In a preferred embodiment such as shown in FIG. 5D cross-section view, the strong magnetic field gradient is produced with the electromagnet with the spacer diverted flux path controlling the fluid flow through the conduit valve with the fluid flow conduit formed in complimentary mating cone poles and cone receiving spacer.

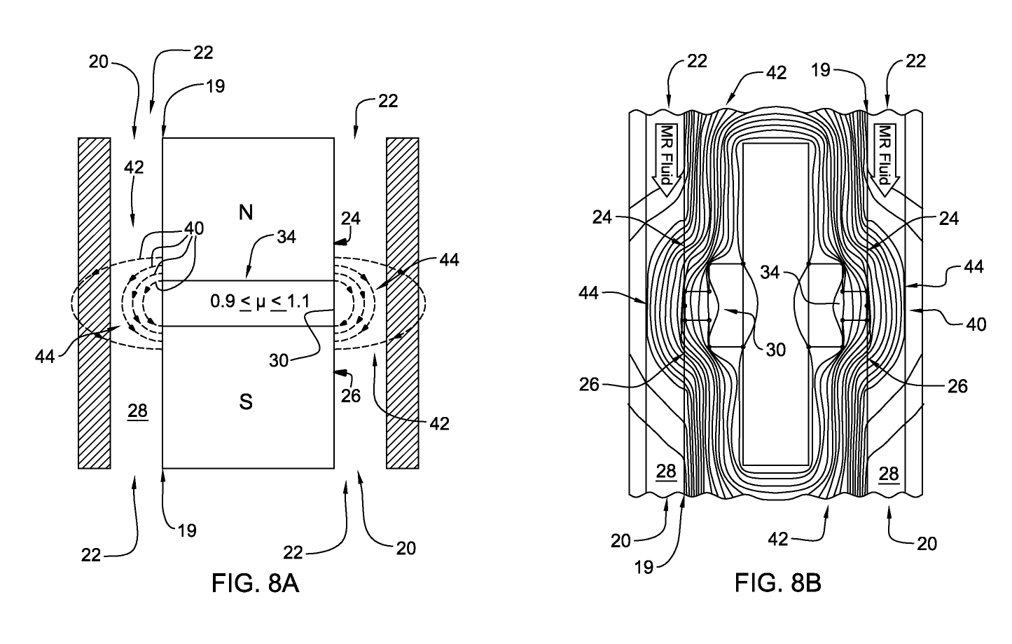

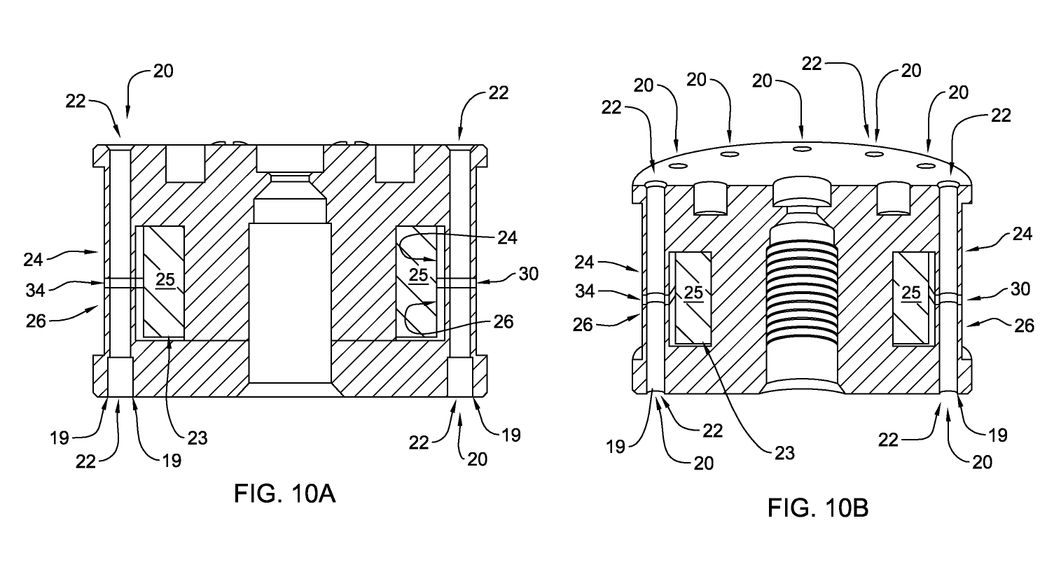

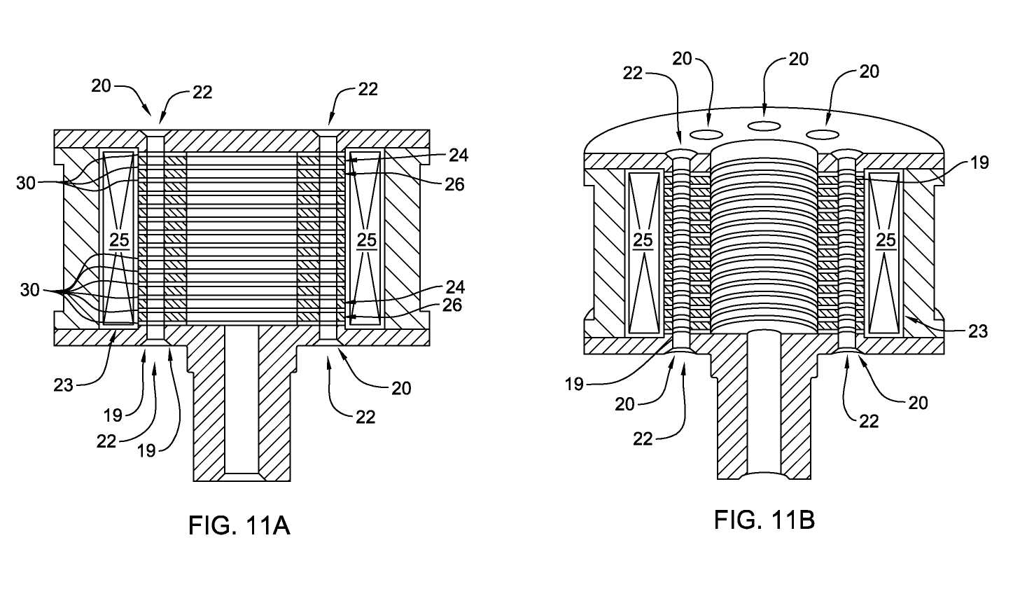

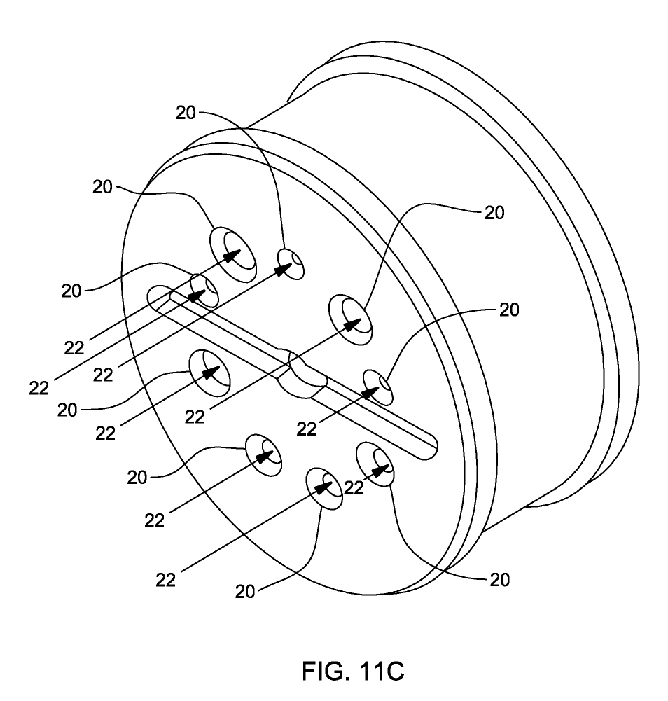

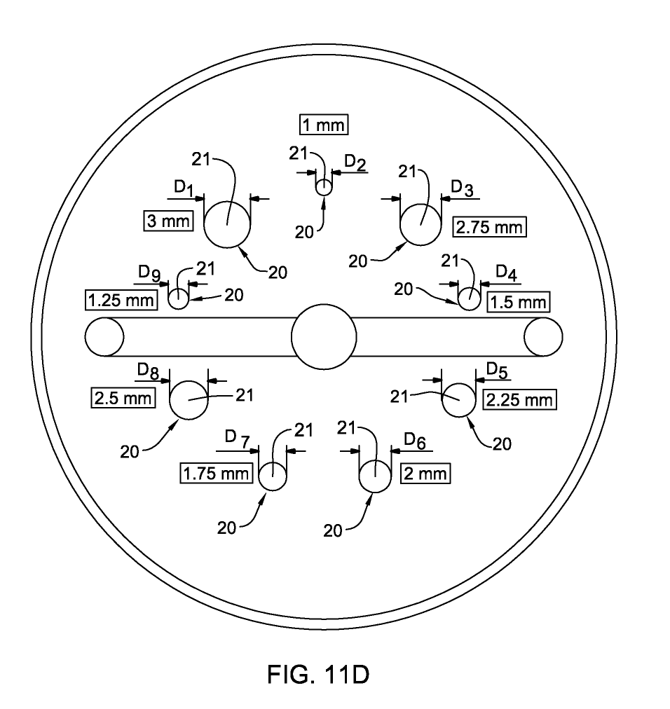

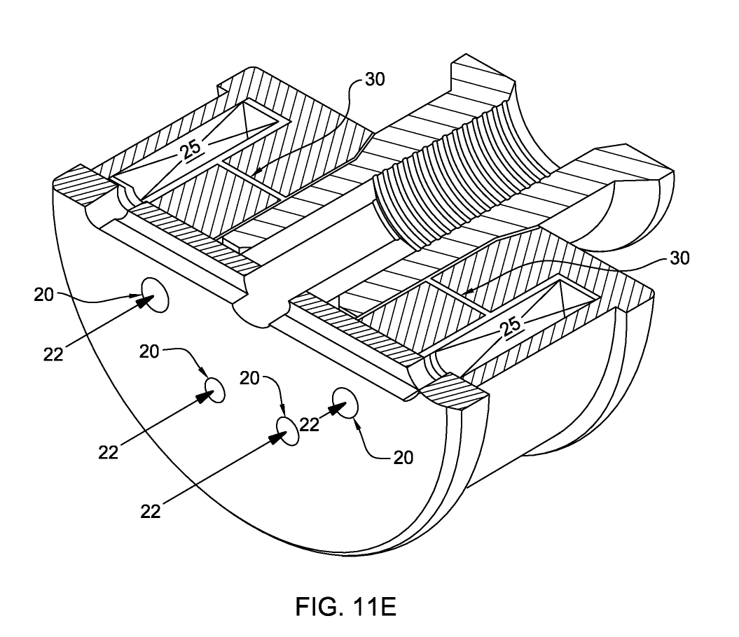

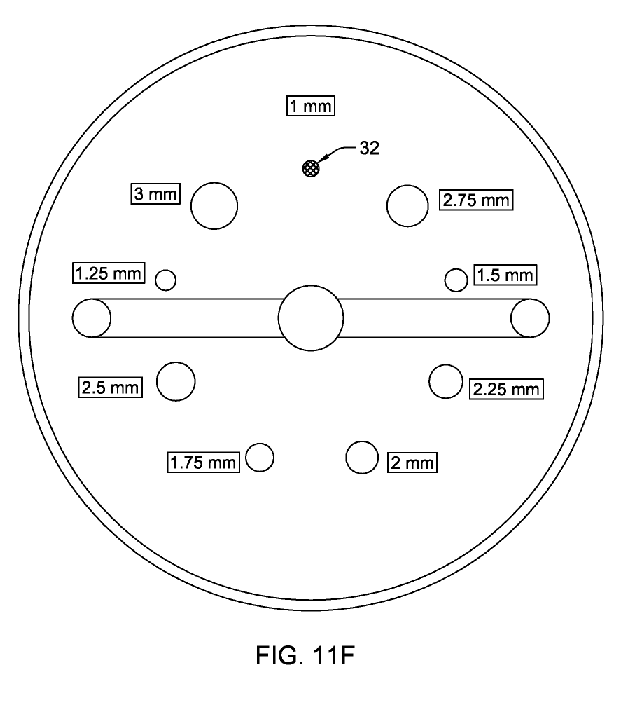

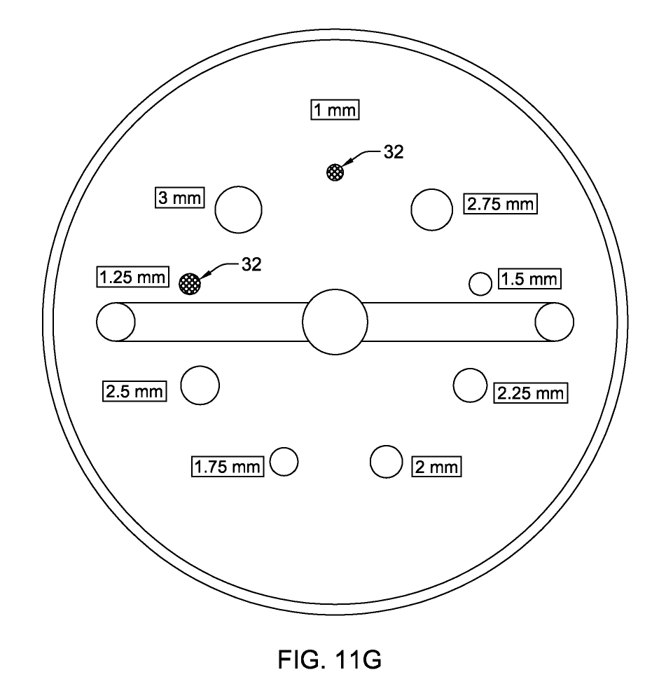

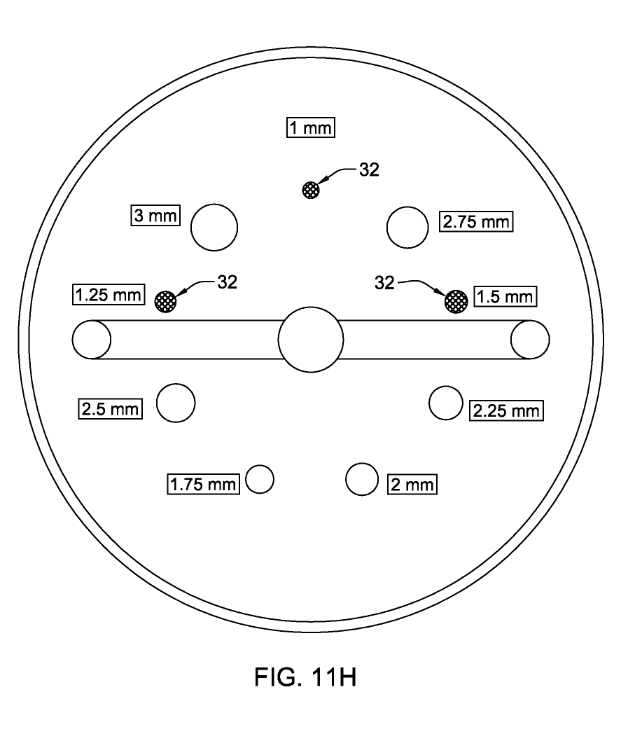

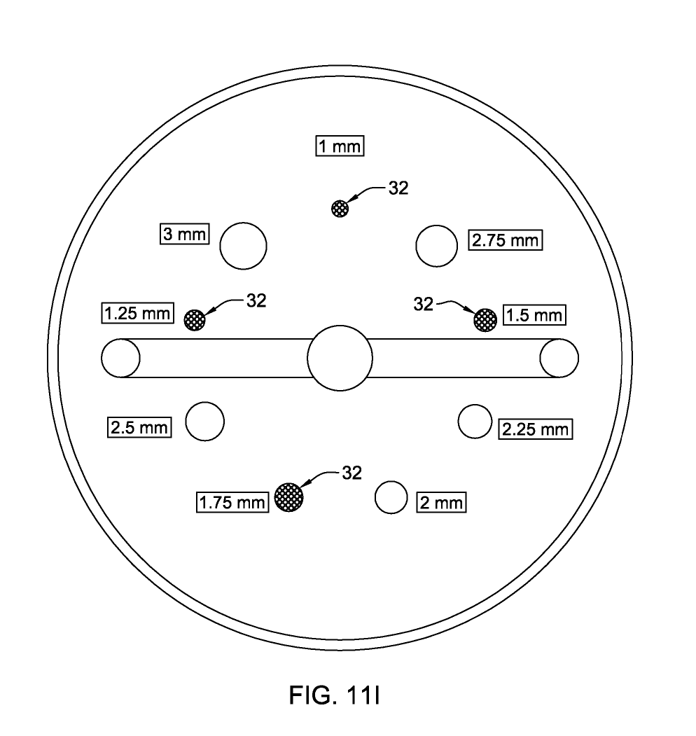

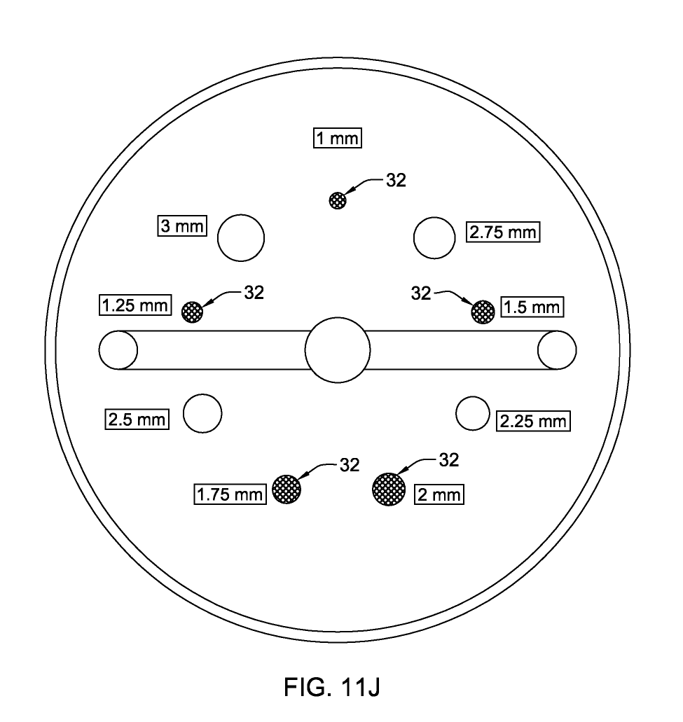

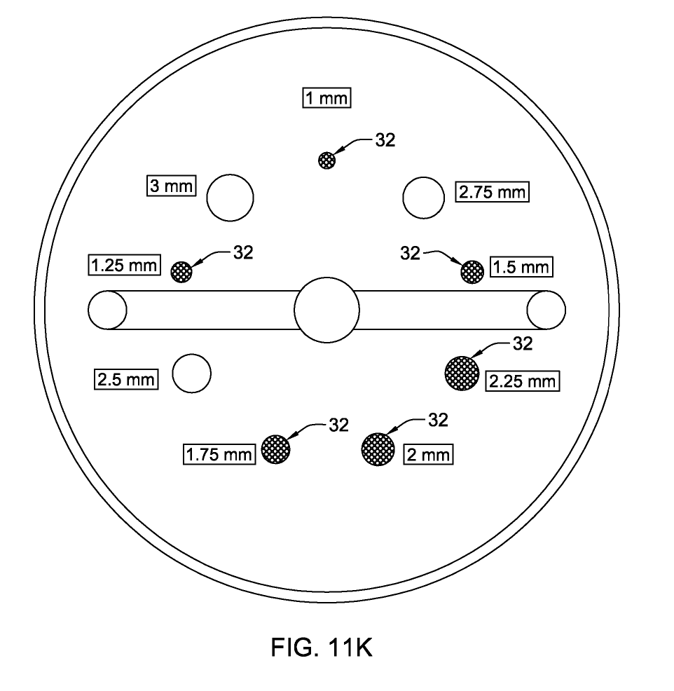

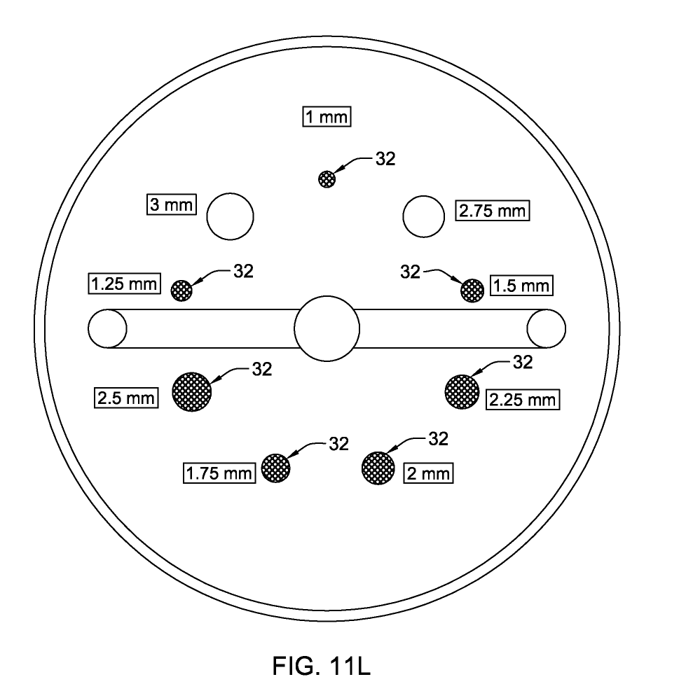

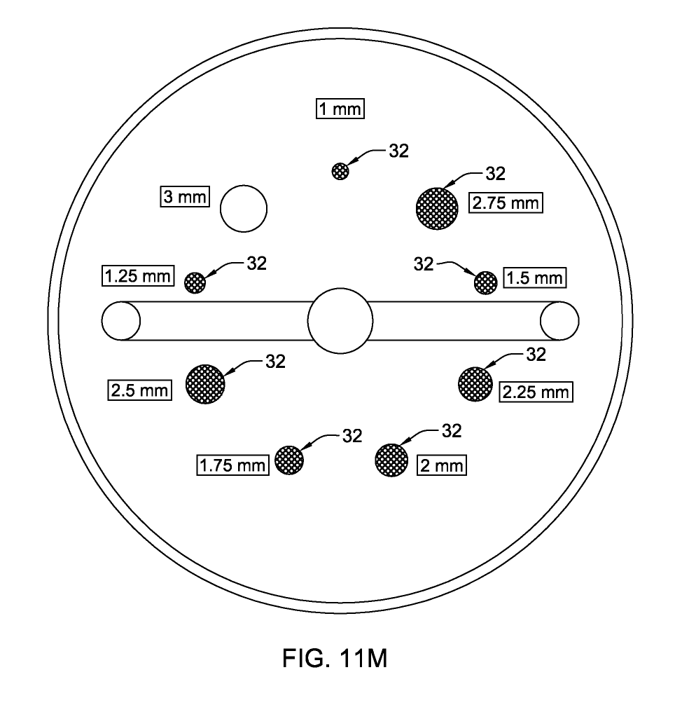

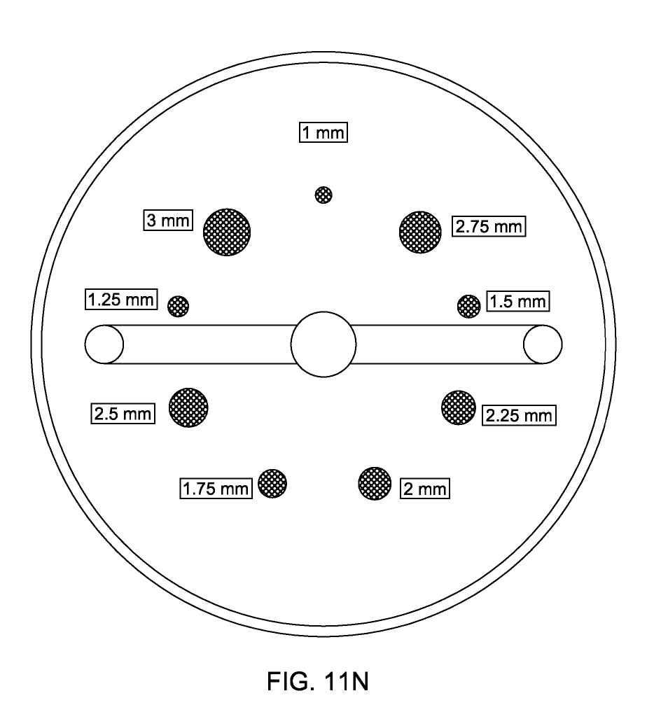

In a preferred embodiment such as shown in FIG. 5E cross-section view, a series of multiple strong magnetic field gradients produced with the electromagnet along the conduit low path with alternating stacked pole pieces and spacers with the plurality of spacer diverted flux path gradients controlling the fluid flow through the multistage conduit valve. In a preferred embodiment such as shown in FIG. 5F cross-section view, a series of multiple strong magnetic field gradients produced with the electromagnet along the conduit flow path with alternating poles and magnetic spacers with reduced outer diameters formed from a single homogeneous magnetic metal perform with the plurality of spacer diverted flux path gradients controlling the fluid flow through the multistage magnetic saturation conduit valve. In a preferred embodiment such as shown in FIG. 6, the magnetic spacer saturation valve has a high magnetic permeability with the conduit poles and spacers in between formed with a magnetic saturation spacer region having an effective spacer thickness, with a series of multiple strong magnetic field gradients produced with the electromagnet along the conduit flow path. In a preferred embodiment such as shown in FIG. 7 cross-section view, a strong magnetic field gradient produced with the electromagnet along the conduit flow path with pole spacer producing an endo-toroidal magnetic flux configuration in orifice flow, with the left side showing the coordinate axis and flow path and the right side showing a finite element model of the flux lines and produced gradient, with a similar endo-toroidal magnetic flux configuration produced utilizing a magnetic spacer 30 when magnetically saturated by the electromagnet. In a preferred embodiment such as shown in FIG. 8 cross-section view, a strong magnetic field gradient produced with the electromagnet along the conduit flow path with the pole spacer providing an exo-toroidal magnetic flux configuration in annular flow, with the right side showing a finite element model of the flux lines and produced gradient, with a similar exo-toroidal magnetic flux configuration produced utilizing a magnetic spacer 30 when magnetically saturated by the electromagnet. In a preferred embodiment such as shown in FIG. 9 cross-section view, a strong magnetic field gradient produced with the electromagnet along the conduit flow path with pole spacer providing an exo-toroidal magnetic flux configuration in the damper piston head with the gradient produced between the damper piston head and the damper outer housing wall, with a similar exo-toroidal magnetic flux configuration produced utilizing a magnetic spacer 30 when magnetically saturated by the electromagnet. In a preferred embodiment such as shown in FIG. 9 the damper outer housing wall is preferably a nonmagnetic damper wall housing with low magnetic permeability and has a substantially low interaction with the flux lines (preferably insubstantial interaction approaching zero), preferably with the magnetic gradient flow conduit maximum strength adjacent the damper piston head wall proximate the spacer 30 and poles and the flow conduit minimum strength adjacent the inside diameter surface of the nonmagnetic damper wall housing. In a preferred embodiment such as shown in FIG. 10 cross-section views, a strong magnetic field gradient is produced with the electromagnet in the motion control damper piston head along the conduit flow path inside the damper piston head with the magnetic flux path from the pole spacer in the damper piston head with the gradient produced internally inside the damper piston head, with a similar internal piston head flow configuration produced utilizing a magnetic spacer 30 when magnetically saturated by the electromagnet. In a preferred embodiment such as shown in FIG. 10 the internal piston head flow conduits are proximate the piston head outside diameter and/or are spaced around and aligned with the damper piston head axis. In a preferred embodiment such as shown in FIG. 11A-B cross-section views, strong magnetic field gradients are produced with the electromagnet in the motion control damper piston head along the conduit flow paths inside the damper piston head with the magnetic flux path from the pole spacer in the damper piston head with the gradient produced internally in the damper piston head, with a similar internal piston head flow configuration produced utilizing a magnetic spacer 30 when magnetically saturated by the electromagnet. In a preferred embodiment such as shown in FIG. 11A-B the piston head includes multistage serial gradient valves and a plurality of parallel flow passages inside the piston head with the internal piston head flow conduits spaced around and aligned with the damper piston head axis. In preferred embodiments such as shown in FIG. 11 the piston head includes a plurality of parallel flow passages inside the piston head with the internal piston head flow conduits spaced around and aligned with the damper piston head axis. In a preferred embodiment such as shown in FIG. 11C-E the plurality of magnetorheological fluid flow conduits 20 have a plurality of relatively different conduit diameters D, with the conduits 20 with the plurality of conduit diameters providing magnetorheological fluid flow paths 22 which are progressively jammed by the application of an increasing greater critical current level supplied to the electromagnet 25 to progressively jam the relatively larger conduits 20 with blockage jams 32. As illustrated progressively from FIG. 11F through 11N a progressively increased supplied critical current level progressively jams the conduits 20 with blockage jams 32. Preferably the damper piston has a plurality of conduits 20 with varying diameters D. As current is applied to the EM coil 25, the conduits 20 and their fluid flow paths 22 will jam progressively, beginning with the smallest diameter orifices. As the small diameter orifices jam, fluid is diverted to the remaining conduits and their orifices. As the current is increased further, other conduits begin to jam, again diverting the fluid to the remaining, larger diameters. This progressive jamming preferably provides a number of discrete force levels as the conduits become jammed.

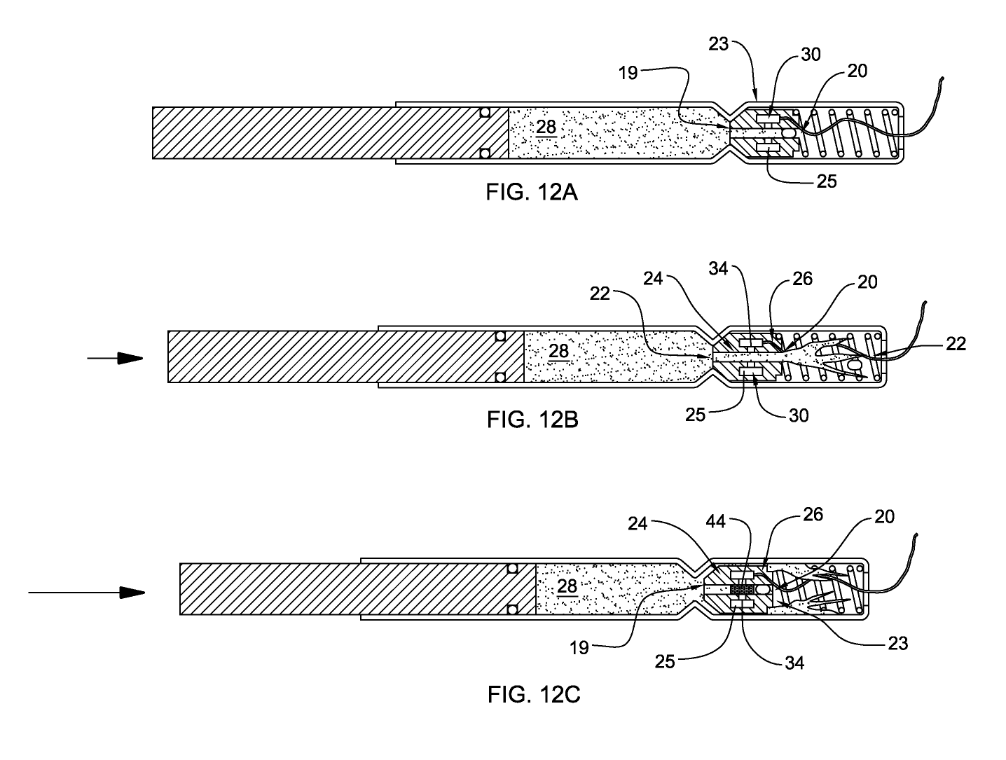

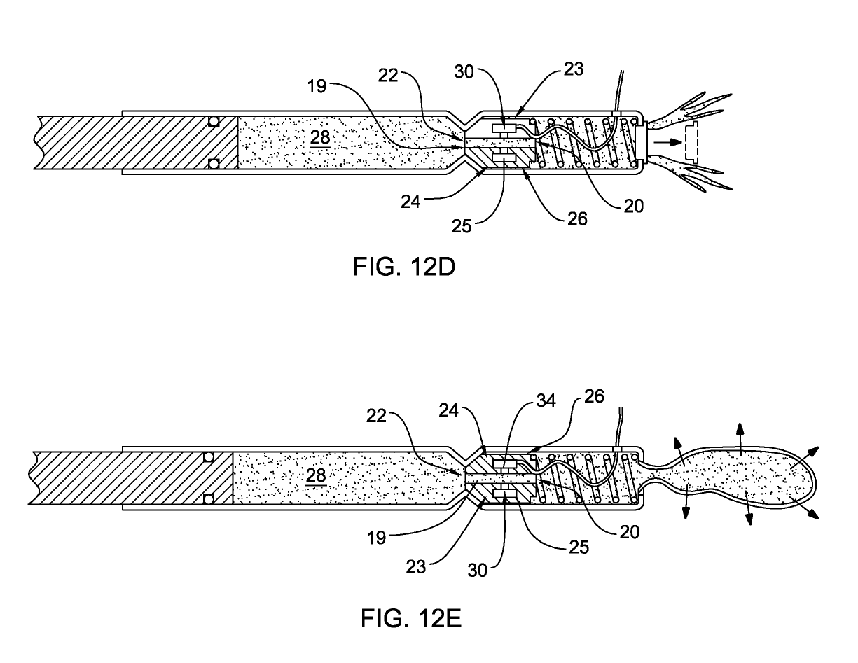

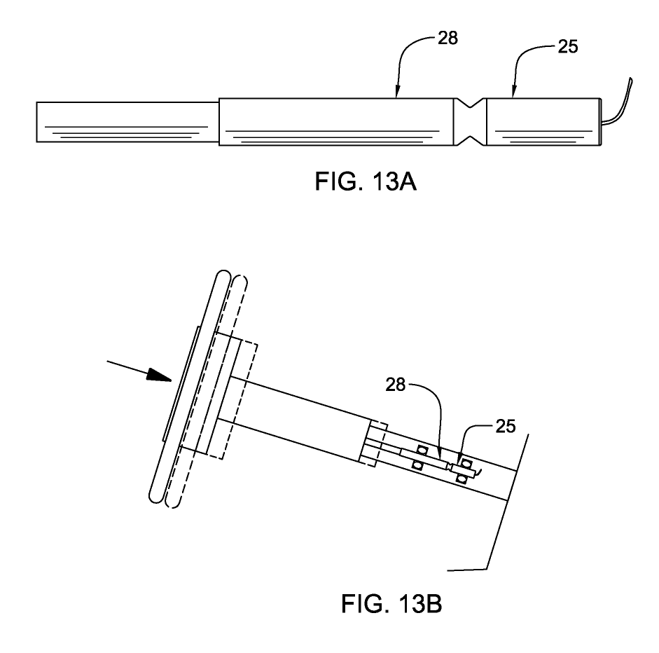

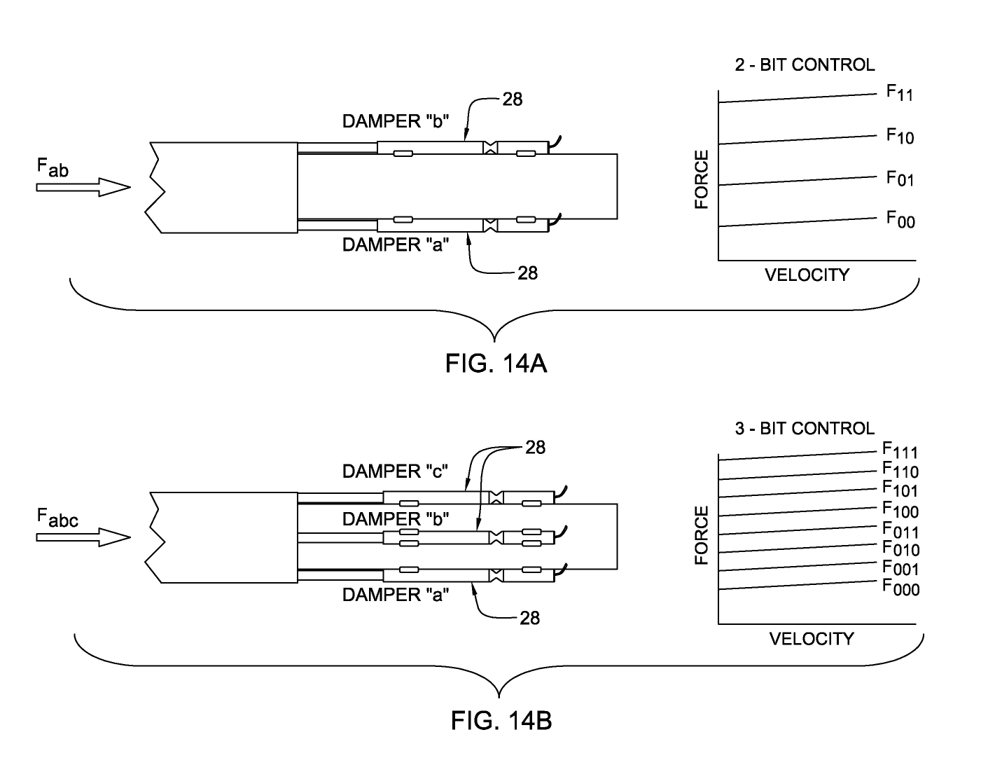

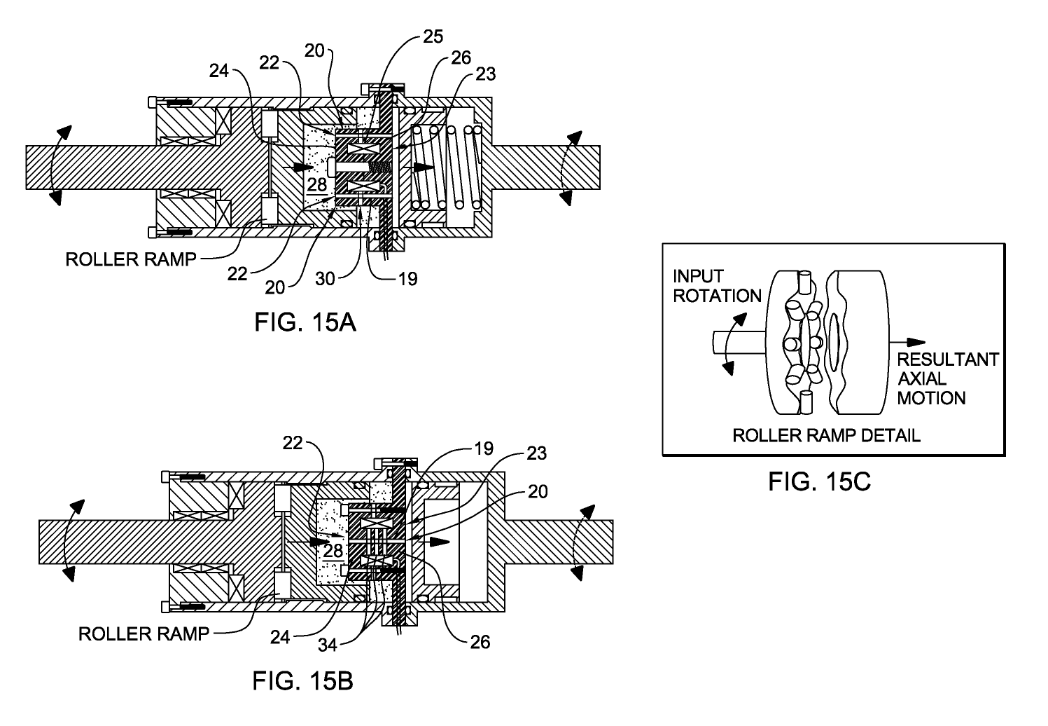

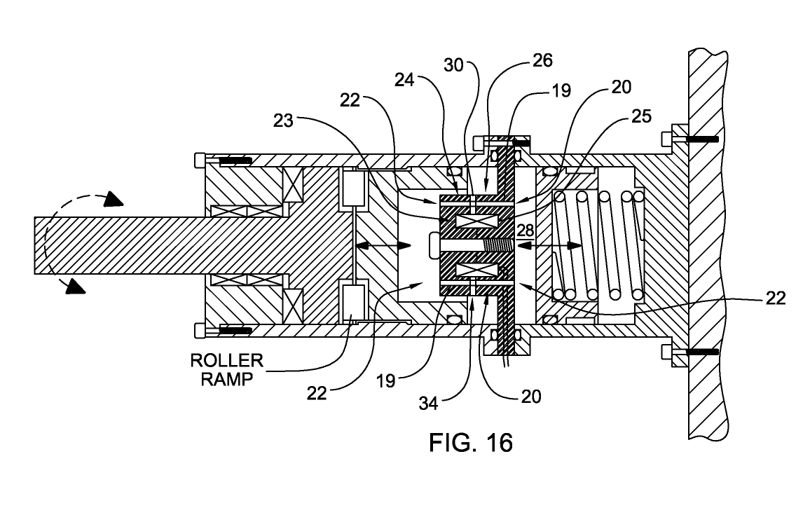

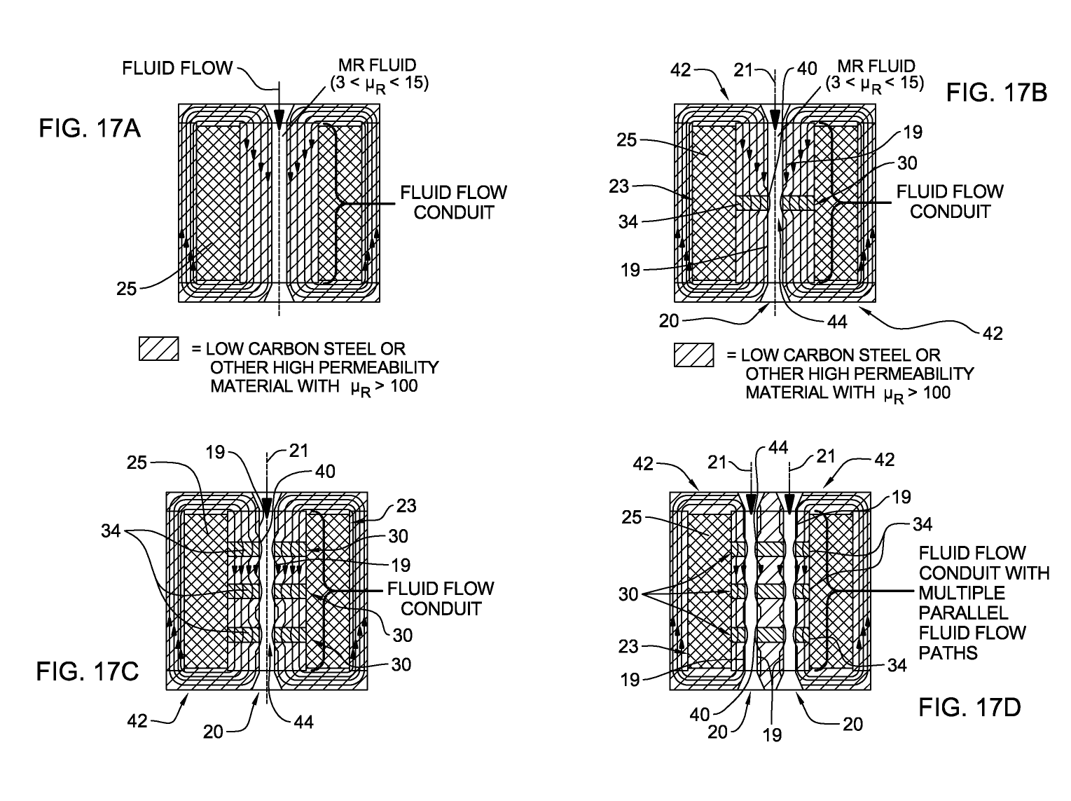

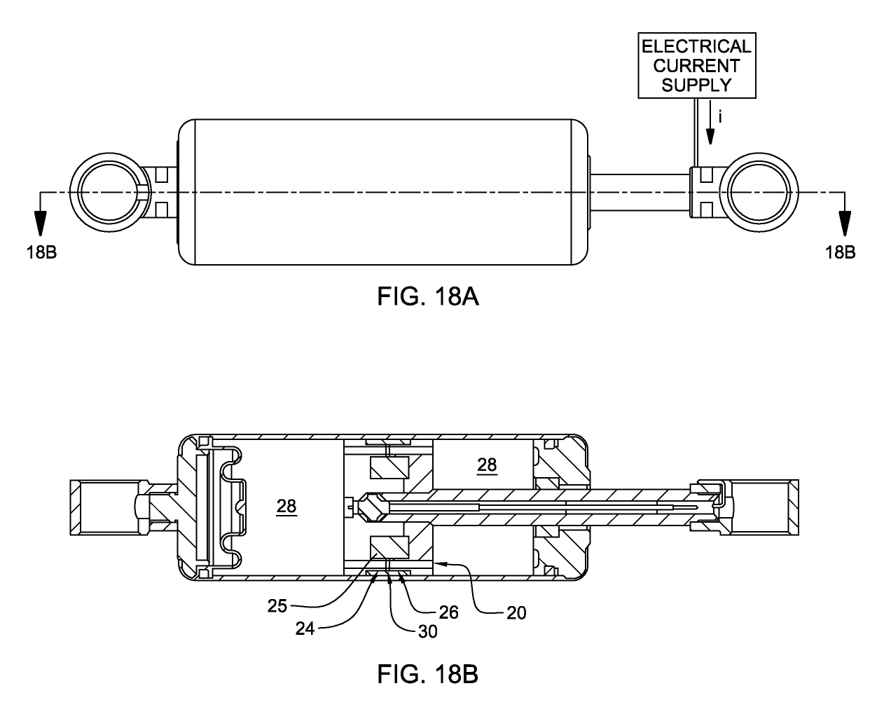

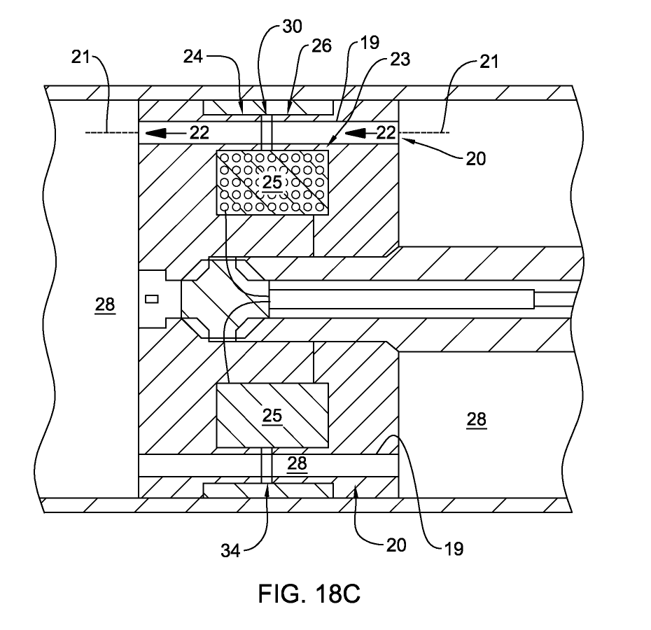

In a preferred embodiment such as shown in FIG. 12 cross-section views, strong magnetic field gradients are produced with the electromagnet in the motion control energy dissipation devices with the magnetic flux path from the pole spacer and poles controlling the release of magnetorheological fluid from the energy dissipation crash control device, with a similar flow configuration produced utilizing a magnetic spacer 30 when magnetically saturated by the electromagnet. In a preferred embodiment such as shown in FIG. 12 the controllable valve is supplied with a current to the electromagnetic coil, preferably a critical current level to produce a jamming pressure, and preferably the coil is provided with a below critical current to provide a first energy crash dissipation level and a higher critical current level to produce the jamming pressure. In a preferred embodiment such as shown in FIG. 13 views, the controllable valve motion control energy dissipation crash device utilize the strong magnetic field gradients produced with the electromagnet with a vehicle steering wheel column, such as with the force of the vehicle occupant crashing against the steering wheel pushing the piston into the outer housing. In a preferred embodiment such as shown in FIG. 14 views, the controllable valve motion control energy dissipation crash device utilizes the strong magnetic field gradients produced with the electromagnet with a vehicle steering wheel column with multiple discrete levels of force available with the crash devices mounted in parallel around the steering column, such as with the force of the vehicle occupant crashing against the steering wheel pushing the piston into the outer housing. In a preferred embodiment such as shown in FIGS. 15 and 16 views, the controllable valve motion control device utilizes the strong magnetic field gradients produced with the electromagnet in a rotary coupler, with the magnetic field gradients controlled to couple the input rotation of the device to the anchored output shaft. Preferably the electromagnet is supplied with a critical current level that jams the valve conduit with a blockage that couples the input shaft with the output shaft. In a preferred embodiment such as shown in FIG. 15 the motion control device is utilized with a vehicle suspension roll bar system to control vehicle suspension motions with the electromagnet supplied with a critical current level that jams the valve conduit with a blockage that couples the input shaft with the output shaft. In a preferred embodiment such as shown in FIG. 16 the motion control rotary coupler device utilizes roller ramps to convert rotation into an axial motion that axially drives a fluid pumping piston, with the piston pumping the magnetorheological fluid through the conduit to couple the motion of the rotating left hand shaft with the anchored right hand side of the coupler with the electromagnet supplied with a critical current level that jams the valve conduit with a coupling blockage, preferably controlled to lock the piston at a rotation periodic detent. FIG. 17 compares a fluid flow conduit that lacks a gradient producing spacer with three fluid flow conduits utilizing gradient producing spacers 30 to create a large discontinuity in the magnetic permeability of the magnetic circuit with the magnetic gradient flux lines bulging out into the fluid. In a preferred embodiment such as shown in FIG. 18 views, the controllable valve motion control device utilizes the strong magnetic field gradients produced with the electromagnet in a damper, preferably with the controllable valve between a first variable volume chamber and a second variable volume chamber filled with the magnetorheological fluid, preferably with the fluid flow conduits controlling the flow of fluid between the damper's variable volume chambers. Preferably with the invention the production of flux lines that leave a first pole and go into the fluid and then into a distal magnetic conduit wall and then back into the fluid and then the second pole are inhibited, preferably such as shown in FIG. 9 with the damper outer tubular housing walls comprised of a nonmagnetic material. Preferably motion control dampers are made with nonmagnetic damper housings with the damper housing having a magnetic permeability less than the magnetorheological fluid that the housing is containing. Preferably a nonuniform magnetic field is formed in the magnetorheological fluid in the conduit valve. In a preferred embodiment the nonuniform magnetic field is utilized to develop a yield strength in only a portion of the fluid in the conduit valve with the fluid and its magnetic iron particles proximate the poles and spacer produced nonuniform magnetic gradient restrained while the more distal fluid is allowed to flow. In a preferred embodiment the flow of magnetorheological fluid is controlled through an encompassing circular orifice can be controlled with a strong but highly non-uniform magnetic field, preferably an oriented magnetic field gradient. Preferably the overall magnetic field strength is used to control the inward distance that such solidification restraining of the magnetorheological fluid occurs to effectively control the encompassing orifice diameter. Preferably a nonuniform magnetic field is utilized to form a particle blockage in the conduit valve to provide a reversible jamming of the valve. Preferably a non-uniform high-gradient magnetic field is generated with the electromagnet to control fluid flow in the valve conduit. Preferably the valve utilizes a magnetic field (H) parallel to the flow of the fluid in the valve conduit. Preferably the magnetic poles are arranged axially along the fluid flow path. Preferably the magnetic field gradient provides for fluid shearing distal from the wall, and preferably proximate to the conduit center axis 21.

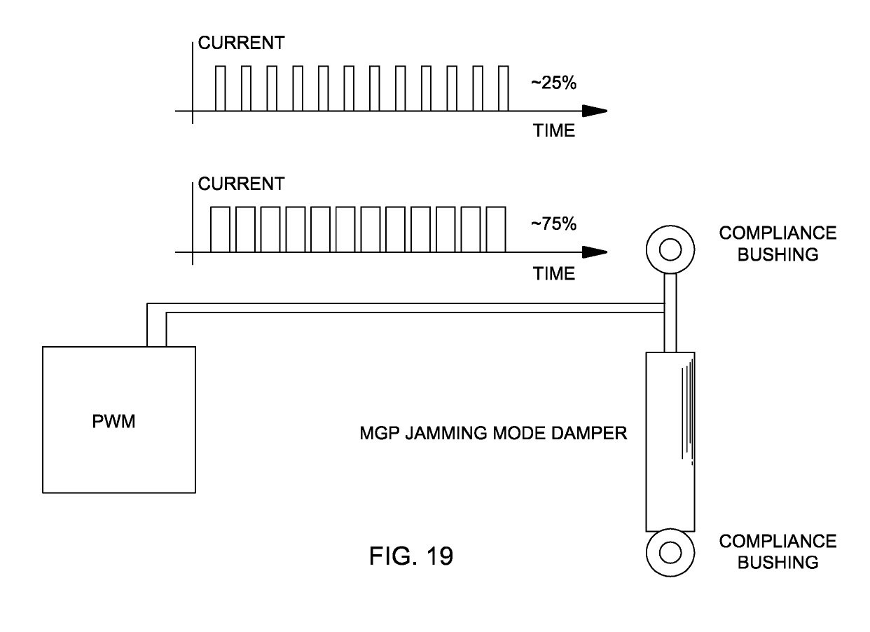

In preferred embodiments a pulse width modulated current is applied to the EM coil 25 to rapidly jam and un-jam the conduit 20 to rapidly reproduce blockage jams 32 in the fluid flow path 22. Preferably a pulse width modulated current is applied to the EM coil 25 to rapidly reproduce blockage jams 32 in the fluid flow path 22 to provide an average force level that is controlled proportionate to the fraction of time the controllable fluid device is in the jammed state. Preferably to provide a satisfactory average force that is relatively smooth an amount of compliance is provided in series with the controllable fluid device that is supplied with the pulse width modulated current, preferably with connecting compliance bushing at opposing ends of controllable fluid damper devices. In preferred embodiments such as shown in FIG. 19 a pulse width modulated current source (PWM) is used to drive the controllable fluid device damper to jam and un-jam with blockage jams 32. The controllable fluid device damper will thus lock and unlock at the pulse frequency. The controllable fluid device damper is preferably placed in a system with some amount of series compliance. In preferred embodiments such compliance includes elastomeric bushings at either end, or other additional compliance may be explicitly added. In a dynamic system force will build up in the damper/compliance while the damper is locked. It will then bleed away as when the damper unlocks.

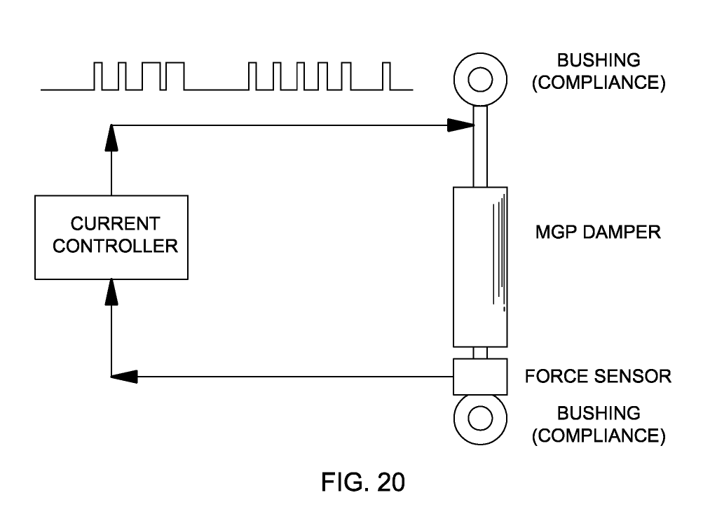

In preferred embodiments current is applied to the EM coil 25 to jam and un-jam the conduit 20 to reproduce blockage jams 32 in the fluid flow path 22 in response to a monitored force level as determined by an inline force sensor. A force sensor (or a displacement/velocity sensor) in series with the controllable fluid device damper preferably provides a control signal in a control feedback loop. If the force exceeds a preset level (or the velocity goes to zero) the controller turns the jamming mode damper from on to off, preferably by reducing the current applied to the EM coil 25 to un-jam the conduit 20. Once the force drops below a second threshold the jamming mode damper is again engaged with a critical level current applied to the EM coil 25 to jam the conduit 20 to reproduce the blockage jam 32 in the fluid flow path 22. In preferred embodiments such as shown in FIG. 20 the conduit of the jamming mode damper is turned on and off by jamming and un-jamming the fluid flow path in the damper in response to the force level as determined by an inline force sensor. If the force sensed by the force sensor exceeds the predetermined target force by a prescribed amount the current controller reduces the current supply level and/or turns off current supply to the damper. If the force sensed by the force sensor is below the target force the current controller increases the level of current supply to the damper. Preferably compliance bushings are provided, with the average force felt by the system smoothed by the series compliance.

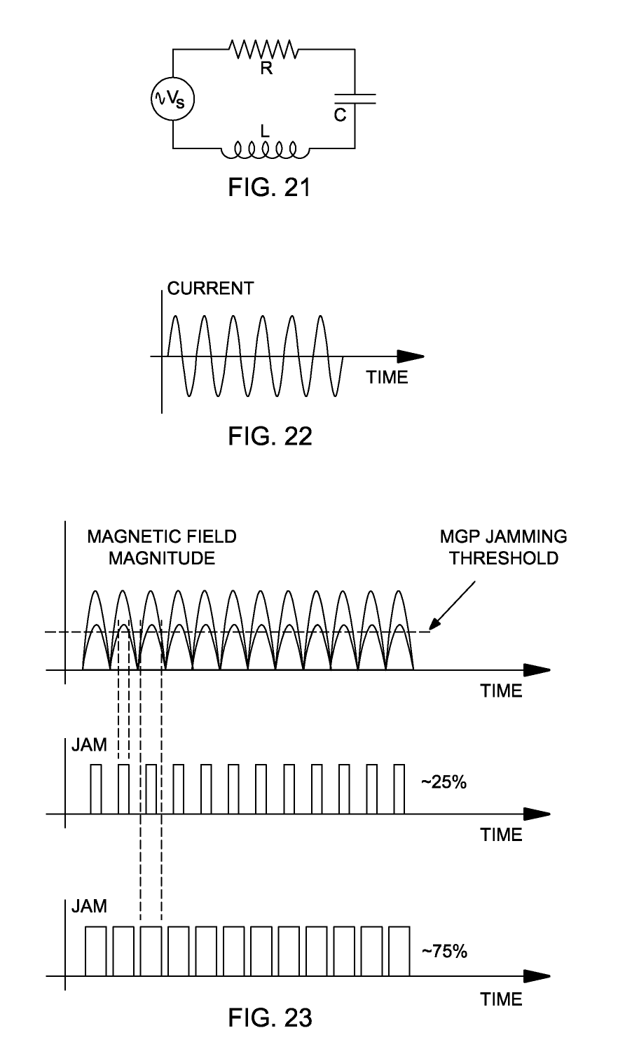

In preferred alternative embodiments proportionate control jamming and un-jamming is provided without the need for a PWM pulse width modulated controller. In preferred embodiments the coil inductance and resistance is coupled with an appropriate capacitance to form an LRC circuit that is driven with an AC voltage or current. The magnetorheological fluid flow conduit valve preferably jams with a blockage jam 32 for that portion of the cycle wherein the absolute value of the magnetic field exceeds the jamming threshold. Preferably by changing the level of the driving voltage and thus the amplitude of the magnetic field provides control of the proportion of the cycle wherein the jamming threshold is exceeded thereby effecting overall proportionate control. Preferably an AC (alternating current) signal is used to drive the magnetorheological fluid flow conduit valve jamming mode inductance L as shown in FIG. 21. Preferably capacitor is added to create a resonant circuit. Preferably R includes the resistance of the coil and perhaps some additional resistance. Preferably the magnetorheological fluid flow conduit valve of the magnetorheological fluid damper is part of a LRC resonant circuit. The system will be at resonance when the driving frequency fₒ=1/[2□*(LC)ˆ0.5].

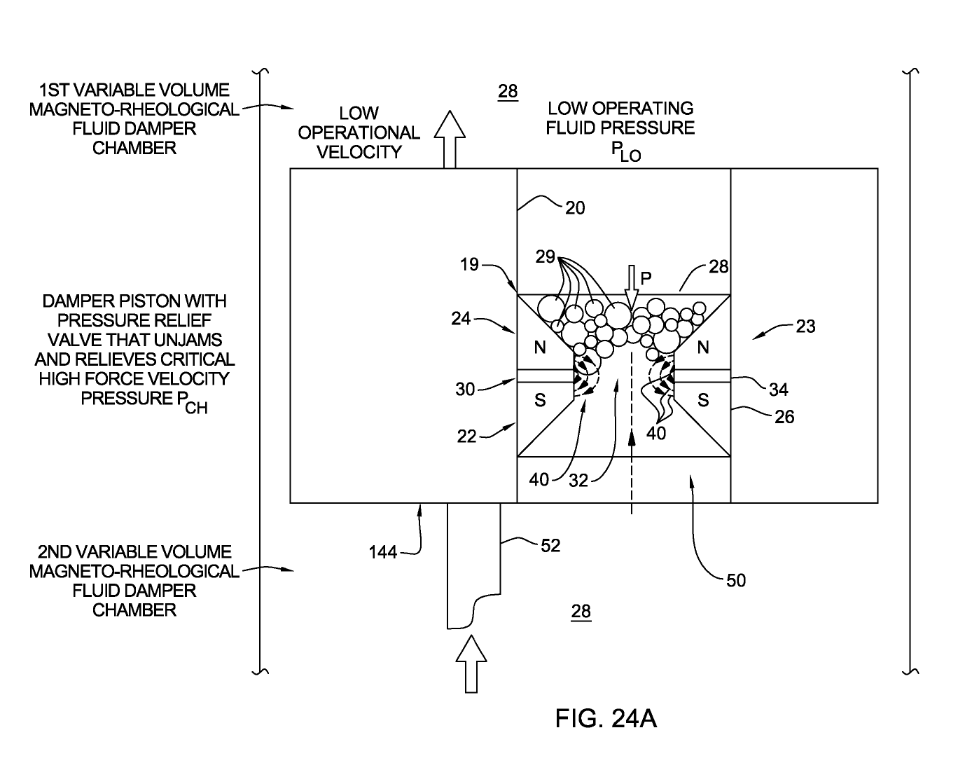

The magnetic field in the magnetorheological fluid flow conduit MGP valve will be proportional to the oscillating current shown in FIG. 22. The magnitude of the magnetic field will rise and fall at twice the driving frequency as shown in FIG. 23. By changing the amplitude of the driving signal the resulting magnitude of the magnetic field will also change accordingly. Preferably this varying amplitude is used to create an effective PWM (pulse width modulated) control of the magnetorheological fluid flow conduit MGP jamming valve of the magnetorheological fluid damper.

The MGP jamming valve acts as an on/off type of magnetorheological fluid damper device. If the strength of the magnetic field is below the jamming threshold then the valve will be open. When the magnetic field strength exceeds the jamming threshold the MGP valve will be locked or closed. Thus with an oscillating magnetic field, the valve will be closed for that portion of the cycle where the magnetic field exceeds the jamming threshold. By changing the amplitude of the oscillating magnetic field we can thus control the proportion of time that the valve is closed as shown in FIG. 23. As shown in the FIG. 23, the lower amplitude oscillation results in a duty cycle of about 25% while the larger amplitude oscillation gives about 75% duty cycle.

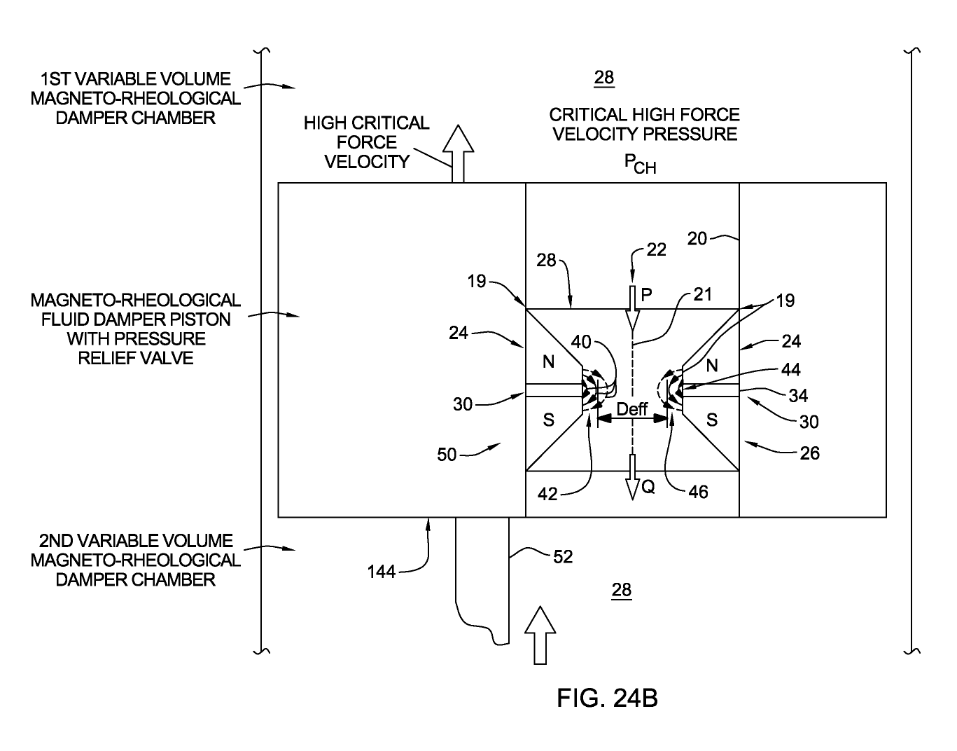

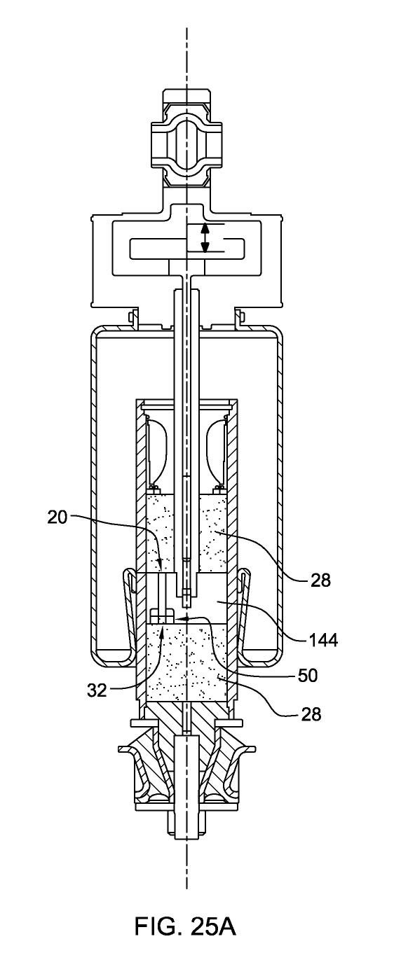

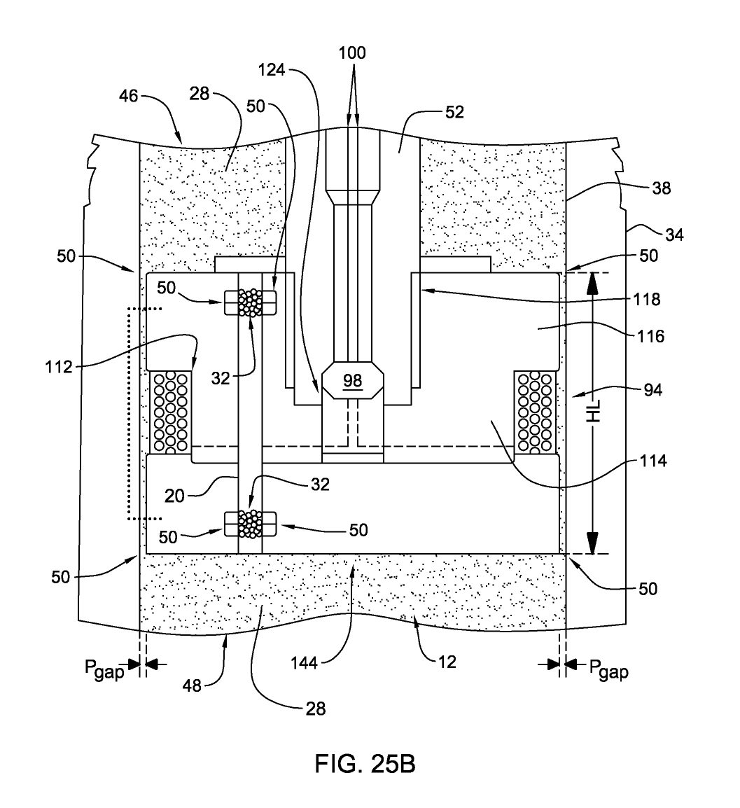

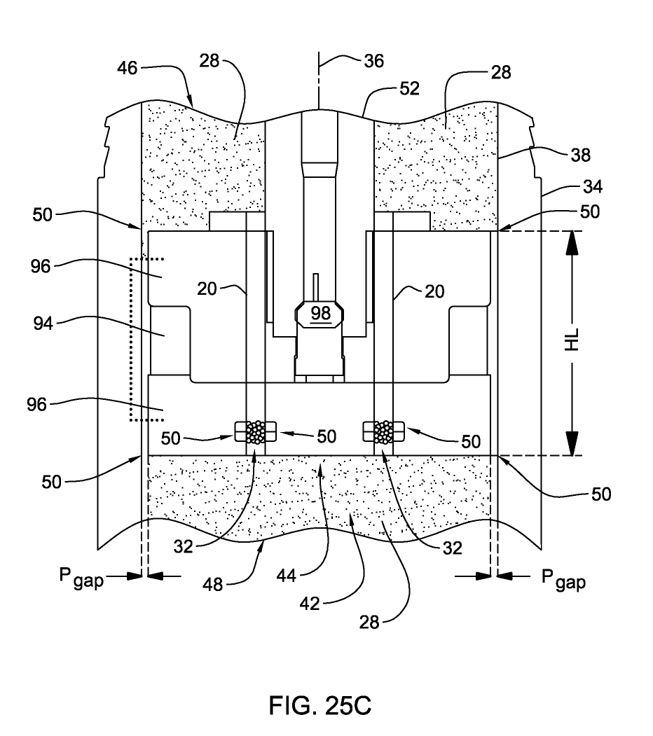

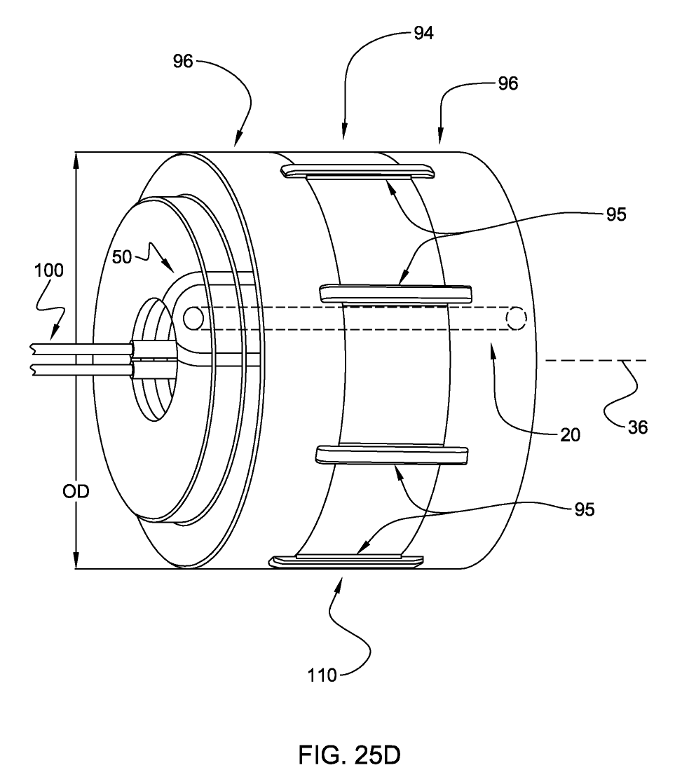

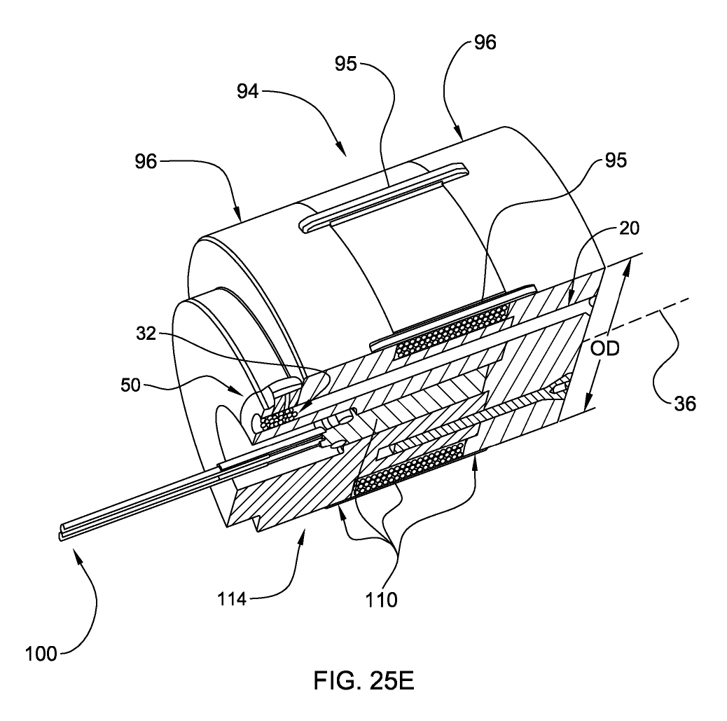

In an embodiment the invention includes controllable fluid valve for controlling a magnetorheological fluid. The controllable fluid valve for controlling a magnetorheological fluid preferably includes a magnetorheological fluid flow conduit 20, a north magnetic pole 24 and a south magnetic pole 26. Preferably the south magnetic pole is proximate the north magnetic pole with a spacer 30 between said south magnetic pole and said north magnetic pole wherein said south magnetic pole and said north magnetic pole generate a plurality of nontraversing magnetic field flux lines 40 that extend into said magnetorheological fluid flow conduit 20 and produce a pressure relief blockage jam 32 in the magnetorheological fluid flow conduit. In an embodiment the invention includes a pressure relief valve for controlling a magnetorheological fluid. The pressure relief valve for controlling a magnetorheological fluid preferably includes a magnetorheological fluid flow conduit 20, a north magnetic pole 24 and a south magnetic pole 26, with the south magnetic pole proximate the north magnetic pole. Preferably the south magnetic pole and said north magnetic pole generate a plurality of jamming magnetic field flux lines 40 that jam the magnetorheological fluid flow conduit 20 with a pressure relief blockage jam 32. In an embodiment the invention includes a motion control device. The motion control device preferably includes a motion control member for moving a magnetorheological fluid during a motion control operation and creating a low operating fluid pressure. The motion control member includes at least a first pressure relief fluid conduit 20, the at least a first pressure relief fluid conduit 20 providing a pressure relief fluid path 22. The at least first pressure relief fluid conduit 20 includes a pressure relief fluid valve 50 for controlling the flow of magnetorheological fluid through the at least first pressure relief fluid conduit 20 wherein the pressure relief fluid valve 50 collects a plurality magnetic particles 29 into a pressure relief fluid flow jam blockage 32 which inhibits a low operating fluid pressure flow through said at least first pressure relief fluid conduit 20. Preferably the motion control member is a damper piston, preferably a damper piston 144 on a piston rod 52. Preferably the motion control member is a damper piston containing a magnetic field generator. FIG. 24A-B show a magnetorheological fluid motion control device with a magnetorheological fluid motion control damper piston 144 with a pressure relief fluid valve 50. In embodiments the invention includes pressure relief fluid valves. Preferably the pressure relief valves are controllable fluid valves for controlling magnetorheological fluid. In a preferred embodiment the controllable fluid pressure relief valve is a magnetorheological fluid passive relief valve located within a damper piston. In a preferred embodiment the pressure relief valve includes a permanent magnet as a magnetic field generator, with the permanent magnet magnetic field generator collecting a plurality of magnetic particles into a pressure relief fluid flow jam blockage which inhibits a low operating fluid pressure flow through said at least first pressure relief fluid conduit. Preferably the pressure relief valve is provided within the damper piston. During normal operation with normal low operational velocity of the piston producing low operating fluid pressure, the valve stays normal operationally closed through jamming with the blockage jam, however when a high velocity event occurs such as a high critical force velocity of the damper piston, the blockage jam is blown away provides for the flow of fluid through the conduit 20 and a lower level of damping. FIG. 25A-E show embodiments of the invention with a motion control device utilizing pressure relief fluid valve 50. Preferably the magnetorheological fluid motion control devices with the magnetorheological fluid motion control damper piston 144 include a pressure relief fluid valve 50 that collect magnetic particles 29 from the magnetorheological fluid in the form of a blockage jam 32. Preferably the pressure relief fluid valve 50 collects the plurality of magnetorheological fluid magnetic particles into a pressure relief fluid flow jam blockage 32 which inhibits the normal damper operation low operating fluid pressure flow through the at least first pressure relief fluid conduit 20 until a high velocity critical force movement of the magnetorheological fluid motion control damper piston 144, which produces a critical high force velocity magnetorheological fluid pressure P_{CH} which un-jams the pressure relief fluid valve 50.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. A controllable fluid valve for controlling a magnetorheological fluid, said controllable fluid valve comprised of a magnetorheological fluid flow conduit with a magnetorheological fluid flow path, a north magnetic pole and a south magnetic pole, said south magnetic pole proximate said north magnetic pole with a spacer between said south magnetic pole and said north magnetic pole wherein said south magnetic pole and said north magnetic pole generate a plurality of nontraversing magnetic field flux lines that extend into said magnetorheological fluid flow path.

2. A controllable fluid valve as claimed in claim 1, wherein said nontraversing magnetic field in said magnetorheological fluid flow path is nonuniform.

3. A controllable fluid valve as claimed in claim 1, wherein said spacer comprises a nonmagnetic spacer.

4. A controllable fluid valve as claimed in claim 1, wherein said spacer has a magnetic permeability centered about 1.

5. A controllable fluid valve as claimed in claim 1, wherein said spacer comprises a magnetic spacer.

6. A controllable fluid valve as claimed in claim 1, wherein said magnetorheological fluid flow conduit has a fluid flow path center axis and said nontraversing magnetic field does not extend beyond said fluid flow path center axis.

7. A controllable fluid valve as claimed in claim 1, said magnetorheological fluid includes a plurality of magnetic particle sizes wherein said nontraversing magnetic field extending into said magnetorheological fluid flow path collects said plurality magnetic particle sizes into a fluid flow blockage.

8. A controllable fluid valve as claimed in claim 1 wherein said controllable fluid valve provides a magnetorheological fluid pressure (kPa) and a magnetorheological fluid flow rate (cm³/sec), with the change in the magnetorheological fluid pressure relative to the change in magnetorheological fluid flow rate increases as the applied magnetic field H increases.

9. A controllable fluid valve as claimed in claim 8 including an electromagnetic coil, said electromagnetic coil supplied with a variable current wherein the rate of change in magnetorheological fluid pressure (kPa) relative to magnetorheological fluid flow rate (cm³/sec) is nonzero as said variable current is varied.

10. A controllable fluid valve for controlling a magnetorheological fluid, said controllable fluid valve comprised of a magnetorheological fluid conduit with a magnetorheological fluid path,
a north magnetic pole and a south magnetic pole, said south magnetic pole proximate said north magnetic pole with a magnetic spacer between said south magnetic pole and said north magnetic pole wherein said magnetic spacer forces a plurality of magnetic flux lines from said north pole out into the magnetorheological fluid path and then back into the south pole.

11. A controllable fluid valve as claimed in claim 10, wherein said magnetorheological fluid conduit includes a longitudinal length conduit wall and a fluid flow path center, said fluid flow path center distal from said conduit wall, said north pole, said magnetic spacer, and said south pole proximate said conduit wall with said magnetic spacer directing said flux lines out towards said path center.

12. A controllable fluid valve as claimed in claim 10 wherein said magnetic spacer and magnetic poles are formed from a piece of magnetic material that has a high initial relative magnetic permeability at a low initial magnetic flux density.

13. A controllable fluid valve as claimed in claim 10 wherein said controllable fluid valve provides a magnetorheological fluid pressure (kPa) and a magnetorheological fluid flow rate (cm³/sec), with the change in the magnetorheological fluid pressure relative to the change in magnetorheological fluid flow rate increases as the applied magnetic field H increases.

14. A controllable fluid valve as claimed in claim 10, wherein said magnetorheological fluid conduit includes a longitudinally extending conduit wall and a longitudinally extending fluid flow path center, said fluid flow path center radially spaced from said conduit wall with a radial distance r wherein said flux lines provide a magnetic field having a component of the magnitude (Hr) that changes along said radial distance r.

15. A controllable fluid valve as claimed in claim 10, wherein said spacer provides a nontraversing magnetic field in said magnetorheological fluid flow path, with said nontraversing magnetic field in said magnetorheological fluid flow path nonuniform.

16. A controllable fluid valve as claimed in claim 10, wherein said magnetorheological fluid flow conduit has a fluid flow path center axis and said flux lines do not extend beyond said fluid flow path center axis.

17. A controllable fluid valve as claimed in claim 10, said magnetorheological fluid includes a plurality of magnetic particles wherein said flux lines extending into said magnetorheological fluid flow path collects said plurality magnetic particles into a fluid flow blockage.

18. A controllable fluid valve for controlling a magnetorheological fluid, said controllable fluid valve comprised of a magnetorheological fluid conduit with a magnetorheological fluid path,
a north magnetic pole and a south magnetic pole, said south magnetic pole proximate said north magnetic pole with a nonmagnetic spacer between said south magnetic pole and said north magnetic pole wherein said nonmagnetic spacer forces a plurality of magnetic flux lines from said north pole out into the magnetorheological fluid path and then back into the south pole.

19. A controllable fluid valve as claimed in claim 18, wherein said magnetic flux lines produce a nontransverse magnetic field in said magnetorheological fluid path, and said nontransverse magnetic field is nonuniform.

20. A controllable fluid valve as claimed in claim 18, wherein said nonmagnetic spacer has a magnetic permeability centered about 1.

21. A controllable fluid valve as claimed in claim 18, wherein said magnetorheological fluid conduit has a fluid flow path center axis and said magnetic flux lines do not extend beyond said fluid flow path center axis.

22. A controllable fluid valve as claimed in claim 18, said magnetorheological fluid includes a plurality of magnetic particles wherein said nontransverse magnetic field extending into said magnetorheological fluid flow path collects said plurality magnetic particles into a fluid flow blockage.

23. A method of controlling magnetorheological fluid flow, said method comprised of:
providing a magnetorheological fluid flow conduit with a magnetorheological fluid flow path, said fluid flow path having a fluid flow axis,
providing a north magnetic pole and a south magnetic pole disposed radially from said fluid flow axis along a radially extending line r, said north magnetic pole spaced from said south magnetic pole along said fluid flow path by a gradient spacer,
producing a magnetic field H with said north magnetic pole and said south magnetic pole, said magnetic field H having a having a magnetic field radial component Hᵣ, wherein dHᵣ/dr≠0

24. A method as claimed in claim 23, wherein said north magnetic pole is disposed proximate said south magnetic pole.

25. A method as claimed in claim 24 wherein said gradient spacer is a nonmagnetic solid.

26. A method as claimed in claim 24 wherein said gradient spacer is a magnetic solid.

27. A method of controlling magnetorheological fluid flow, said method comprised of:
providing a magnetorheological fluid flow conduit with a magnetorheological fluid flow path,
providing a north magnetic pole and a south magnetic pole,
producing a magnetic field with said north magnetic pole and said south magnetic pole, with said magnetic field extending into said magnetorheological fluid flow path while inhibiting said magnetic field from traversing said magnetorheological fluid flow path.

28. A method as claimed in claim 27, wherein said north magnetic pole is disposed proximate said south magnetic pole.

29. A method as claimed in claim 28 wherein said north magnetic pole is separated from said south magnetic pole with a gradient producing spacer.

30. A method of making a magnetorheological fluid flow control valve, said method comprised of:
providing a magnetorheological fluid flow conduit with a magnetorheological fluid flow path,
providing a north magnetic pole and a south magnetic pole,
disposing said south magnetic pole proximate said north magnetic pole with a spacer between said south magnetic pole and said north magnetic pole wherein said south magnetic pole and said north magnetic pole generate a nontransverse magnetic field that extends into said magnetorheological fluid flow path.

31. A method as claimed in claim 30, said method including positioning said south magnetic pole and said north magnetic pole proximate said magnetorheological fluid flow conduit and inhibiting said magnetic field from traversing said magnetorheological fluid flow path.

32. A motion control device, said motion control device comprised of a magnetorheological fluid path containing a magnetorheological fluid, said device including a north magnetic pole and a south magnetic pole, said south magnetic pole proximate said north magnetic pole with a spacer between said south magnetic pole and said north magnetic pole wherein said south magnetic pole and said north magnetic pole generate a nontraversing magnetic field that extends into said magnetorheological fluid path.

33. A motion control device, said motion control device comprised of a magnetorheological fluid path containing a magnetorheological fluid with a device wall, said device including a north magnetic pole and a south magnetic pole proximate said device wall, said south magnetic pole proximate said north magnetic pole with a flux line gradient producer between said south magnetic pole and said north magnetic pole wherein said south magnetic pole and said north magnetic pole generate a plurality of magnetic field flux lines that extends out from said device wall and into said magnetorheological fluid path and provide an increased magnetic field gradient proximate said device wall.

34. A magnetorheological fluid motion control device, said magnetorheological fluid motion control device comprised of a magnetorheological fluid piston including a north magnetic pole and a south magnetic pole, said south magnetic pole proximate said north magnetic pole with a flux line gradient producer between said south magnetic pole and said north magnetic pole, said magnetorheological fluid piston including a plurality of magnetorheological fluid conduits, each of said magnetorheological fluid conduits providing a magnetorheological fluid path through said magnetorheological fluid piston wherein said south magnetic pole and said north magnetic pole generate a plurality of magnetic field flux lines that extends out into said magnetorheological fluid paths.

35. A magnetorheological fluid motion control device as claimed in claim 34 including a means for jamming at least one of said magnetorheological fluid conduits.

36. A magnetorheological fluid motion control device as claimed in claim 34 wherein said plurality of magnetorheological fluid conduits includes at least a first conduit having a first conduit diameter and at least a second conduit having a second conduit diameter.

37. A motion control device, said motion control device comprised of a fluid control piston including a north magnetic pole and a south magnetic pole, said south magnetic pole proximate said north magnetic pole with a flux line gradient producer between said south magnetic pole and said north magnetic pole, said fluid piston including a plurality of fluid conduits, said fluid conduits providing fluid paths through said fluid piston, said plurality of fluid conduits including at least a first smaller conduit having a first conduit smaller diameter and at least a second larger conduit having a second conduit larger diameter wherein said south magnetic pole and said north magnetic pole generate a plurality of jamming magnetic field flux lines that extends out into said magnetorheological fluid paths.

38. A motion control device as claimed in claim 37 including a means for supplying a jamming current level to an electromagnet.

39. A method of controlling magnetorheological fluid flow, said method comprised of:
providing an electromagnet,
providing a magnetorheological fluid,
providing a magnetorheological fluid flow conduit with a conduit wall for containing said magnetorheological fluid, said with magnetorheological fluid flow conduit having a magnetorheological fluid flow path along said conduit wall,
producing a magnetic gradient in said magnetorheological fluid proximate said conduit wall with said electromagnet.

40. A method as claimed in claim 39, said method including providing a current level to said electromagnet to form a blockage jam in said magnetorheological fluid flow conduit.

41. A method as claimed in claim 40, said method including jamming said magnetorheological fluid flow conduit and un-jamming magnetorheological fluid flow conduit.

42. A controllable fluid valve for controlling a magnetorheological fluid, said controllable fluid valve comprised of a magnetorheological fluid flow conduit, a north magnetic pole and a south magnetic pole, said south magnetic pole proximate said north magnetic pole with a spacer between said south magnetic pole and said north magnetic pole wherein said south magnetic pole and said north magnetic pole generate a plurality of nontraversing magnetic field flux lines that extend into said magnetorheological fluid flow conduit and produce a pressure relief blockage jam in said magnetorheological fluid flow conduit.

43. A pressure relief valve for controlling a magnetorheological fluid, said pressure relief valve comprised of a magnetorheological fluid flow conduit, a north magnetic pole and a south magnetic pole, said south magnetic pole proximate said north magnetic pole wherein said south magnetic pole and said north magnetic pole generate a plurality of jamming magnetic field flux lines that jam the magnetorheological fluid flow conduit with a pressure relief blockage jam.

44. A motion control device, said motion control device comprised of a motion control member for moving a fluid during a motion control operation and creating a low operating fluid pressure, said motion control member including at least a first pressure relief fluid conduit, said at least a first pressure relief fluid conduit providing a pressure relief fluid path, said at least first pressure relief fluid conduit including a pressure relief fluid valve for controlling the flow of magnetorheological fluid through said at least first pressure relief fluid conduit wherein said pressure relief fluid valve collects a plurality magnetic particles into a pressure relief fluid flow jam blockage which inhibits a low operating fluid pressure flow through said at least first pressure relief fluid conduit.

45. A motion control device as claimed in claim 44 wherein said motion control member is comprised of a damper piston.

46. A motion control device as claimed in claim 44 wherein said motion control member is comprised of a damper piston containing a magnetic field generator.
